(19) United States
(12) Patent Application Publication
(10) Pub. No.: US 2018/0220450 A1
(43) Pub. Date: Aug. 2, 2018

(54) USER EQUIPMENTS, BASE STATIONS AND METHODS

(71) Applicant: Sharp Laboratories of America, Inc., Camas, WA (US)

(72) Inventors: Tatsushi Aiba, Vancouver, WA (US); Jia Sheng, Vancouver, WA (US); Toshizo Nogami, Vancouver, WA (US)

(21) Appl. No.: 15/886,155

(22) Filed: Feb. 1, 2018

Related U.S. Application Data
(63) Continuation of application No. PCT/US2018/016210, filed on Jan. 31, 2018.
(60) Provisional application No. 62/453,927, filed on Feb. 2, 2017.

(51) Int. Cl. H04W 74/00; H04W 74/08; H04W 56/00; H04W 72/04

(52) U.S. Cl. CPC H04W 74/004; H04W 74/0833; H04W 74/04; H04W 72/0446; H04W 56/001

(57) ABSTRACT

A user equipment (UE) is described. The UE receives downlink signals including, at least, a primary synchronization signal (PSS) and a secondary synchronization signal (SSS). The UE also receives an index for a plurality of occasions for a PRACH. Each of the plurality of occasions for the PRACH are associated with each of the downlink signals including, at least, the PSS and the SSS. The UE further receives information for a plurality of groups of random access preambles. The UE additionally selects a random access preamble from a set of random access preambles in a group of the random access preambles. The UE also determines, based on the received downlink signals including, at least, the PSS and the SSS, an occasion for the PRACH from the plurality of occasions for the PRACH. The UE further transmits the selected random access preamble using the determined occasion for the PRACH.

### RELATED APPLICATIONS

This application is related to and claims priority from U.S. Provisional Patent Application No. 62/453,927, entitled “USER EQUIPMENTS, BASE STATIONS AND METHODS,” filed on Feb. 2, 2017, which is hereby incorporated by reference herein, in its entirety.

### TECHNICAL FIELD

The present disclosure relates generally to communication systems. More specifically, the present disclosure relates to new signaling, procedures, user equipment (UE) and base stations for user equipments, base stations and methods.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more gNBs and one or more user equipments (UEs) in which systems and methods for uplink transmission may be implemented;

FIG. 2 is a diagram illustrating one example of a resource grid for the downlink;

FIG. 3 is a diagram illustrating one example of a resource grid for the uplink;

FIG. 4 shows examples of downlink (DL) control channel monitoring regions;

FIG. 5 shows examples of DL control channels, which may include more than one control channel element;

FIG. 6 shows examples of communications between the gNB and the UE;

FIG. 7 is a table illustrating an example of a random access configuration;

FIG. 8 shows an example of a random access procedure;

FIG. 9 shows another example of a random access procedure;

FIG. 10 illustrates various components that may be utilized in a UE;

FIG. 11 illustrates various components that may be utilized in a gNB;

FIG. 12 is a block diagram illustrating one implementation of a UE in which systems and methods for performing uplink transmissions may be implemented;

FIG. 13 is a block diagram illustrating one implementation of a gNB in which systems and methods for performing uplink transmissions may be implemented;

FIG. 14 shows examples of several numerologies;

FIG. 15 shows examples of subframe structures for the numerologies that are shown in FIG. 14;

FIG. 16 shows examples of slots and sub-slots;

FIG. 17 shows examples of scheduling timelines;

FIG. 18 is a block diagram illustrating one implementation of a gNB;

FIG. 19 is a block diagram illustrating one implementation of a UE;

FIG. 20 is a flow diagram illustrating a communication method of a UE; and

FIG. 21 is a flow diagram illustrating a communication method of a base station apparatus (gNB).

### DETAILED DESCRIPTION

A user equipment is described. The UE includes receiving circuitry configured to receive downlink signals including, at least, a primary synchronization signal (PSS) and a secondary synchronization signal (SSS). The receiving circuitry is also configured to receive an index for a plurality of occasions for a physical random access channel (PRACH), each of the plurality of occasions for the PRACH being associated with each of the downlink signals including, at least, the PSS and the SSS. The receiving circuitry is further configured to receive information for a plurality of groups of random access preambles, each of the plurality of groups of the random access preambles being associated with the each of the downlink signals including, at least, the PSS and the SSS.

The UE also includes higher layer processing circuitry configured to select a random access preamble from a set of random access preambles in a group of the random access preambles, the set of the random access preambles in the group of the random access preambles being determined, based on the received downlink signals including, at least, the PSS and the SSS, from the plurality of groups of the random access preambles. The higher layer processing circuitry is also configured to determine, based on the received downlink signals including, at least, the PSS and the SSS, an occasion for the PRACH from the plurality of occasions for the PRACH. The UE also includes transmitting circuitry configured to transmit the selected random access preamble using the determined occasion for the PRACH.

The selected random access preamble may be transmitted in a contention based random access procedure or in a non-contention based random access procedure. The set of the random access preambles in the group of the random access preambles may be determined, based on a measurement of the received downlink signals including, at least, the PSS and the SSS, from the plurality of groups of the random access preambles. The occasion for the PRACH may be determined, based on the measurement of the received downlink signals including, at least, the PSS and the SSS, from the plurality of occasions for the PRACH.

A base station apparatus is also described. The base station apparatus includes transmitting circuitry configured to transmit downlink signals including, at least, a PSS and an SSS. The transmitting circuitry is also configured to transmit an index for a plurality of occasions for a PRACH, each of the plurality of occasions for the PRACH being associated with each of the downlink signals including, at least, the PSS and the SSS. The transmitting circuitry is further configured to transmit information for a plurality of groups of random access preambles, each of the plurality of groups of the random access preambles being associated with the each of the downlink signals including, at least, the PSS and the SSS. The base station apparatus also includes receiving circuitry configured to receive a random access preamble using an occasion for the PRACH. The random access preamble may be selected from a set of random access preambles in a group of the random access preambles. The set of the random access preambles in the group of the random access preambles is determined, based on the transmitted downlink signals including, at least, the PSS and the SSS, from the plurality of groups of the random access preambles. The occasion for the PRACH is determined, based on the transmitted downlink signals including, at least, the PSS and the SSS, from the plurality of occasions for the PRACH.

A communication method of a user equipment is also described. The method includes receiving downlink signals including, at least, a PSS and a SSS. The method also includes receiving an index for a plurality of occasions for a PRACH, each of the plurality of occasions for the PRACH being associated with each of the downlink signals including, at least, the PSS and the SSS. The method further includes receiving information for a plurality of groups of random access preambles, each of the plurality of groups of the random access preambles being associated with the each of the downlink signals including, at least, the PSS and the SSS. The method additionally includes selecting a random access preamble from a set of random access preambles in a group of the random access preambles, the set of the random access preambles in the group of the random access preambles being determined, based on the received downlink signals including, at least, the PSS and the SSS, from the plurality of groups of the random access preambles. The method also includes determining, based on the received downlink signals including, at least, the PSS and the SSS, an occasion for the PRACH from the plurality of occasions for the PRACH. The method further includes transmitting the selected random access preamble using the determined occasion for the PRACH.

A communication method of a base station apparatus is also described. The method includes transmitting downlink signals including, at least, a PSS and a SSS. The method also includes transmitting an index for a plurality of occasions for PRACH, each of the plurality of occasions for the PRACH being associated with each of the downlink signals including, at least, the PSS and the SSS. The method further includes transmitting information for a plurality of groups of random access preambles, each of the plurality of groups of the random access preambles being associated with each of the downlink signals including, at least, the PSS and the SSS. The method additionally includes receiving a random access preamble using an occasion for the PRACH. The random access preamble is selected from a set of random access preambles in a group of the random access preambles. The set of the random access preambles in the group of the random access preambles is determined, based on the transmitted downlink signals including, at least, the PSS and the SSS, from the plurality of the random access preambles. The occasion for the PRACH is determined, based on the transmitted downlink signals including, at least, the PSS and the SSS, from the plurality of occasions for the PRACH.

Another UE is described. The UE communicates with a base station apparatus. The UE includes receiving circuitry configured to receive information. The information is utilized for configuring an association of a transmission beam at the base station apparatus and a reception beam at the base station apparatus. The UE also includes transmitting circuitry configured to transmit a random access preamble on a transmission beam at the UE using one or more Physical Random Access Channel (PRACH) resources. A number of the one or more PRACH resources is determined based on the information.

Another base station apparatus is also described. The base station apparatus communicates with a user equipment (UE). The base station includes transmitting circuitry configured to transmit information. The information is utilized for configuring an association of a transmission beam at the base station apparatus and a reception beam at the base station apparatus. The base station apparatus also includes receiving circuitry configured to receive a random access preamble on a reception beam at the base station apparatus using one or more Physical Random Access Channel (PRACH) resources. A number of the one or more PRACH resources is determined based on the information.

A method of a user equipment (UE) that communicates with a base station apparatus is also described. The method includes receiving information that is utilized for configuring an association of a transmission beam at the base station apparatus and a reception beam at the base station apparatus. The method also includes transmitting a random access preamble on a transmission beam at the UE using one or more Physical Random Access Channel (PRACH) resources. A number of the one or more PRACH resources is determined based on the information.

A method of a base station apparatus that communicates with a user equipment (UE) is also described. The method includes transmitting information. The information is utilized for configuring an association of a transmission beam at the base station apparatus and a reception beam at the base station apparatus. The method also includes receiving a random access preamble on a reception beam at the base station apparatus using one or more Physical Random Access Channel (PRACH) resources. A number of the one or more PRACH resources is determined based on the information.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra-Reliable and Low Latency Communication) transmission and eMTC (massive Machine Type Communication) transmission. Also, in NR, single-beam and/or multi-beam operations are considered for downlink and/or uplink transmissions.

In order for the services to use the time/frequency/space resource efficiently, it would be useful to be able to efficiently control initial access procedures. Therefore, a procedure for efficient control of initial access should be designed. However, the detailed design of a procedure for an initial access has not been studied yet.

In some approaches, a UE may determine the number of the selected Physical Random Access Channel (e.g., the PRACH time-frequency resources (e.g., the PRACH time resources and/or the PRACH frequency resources)) based on information transmitted by the gNB. The gNB may transmit, as the information, information used for configuring a first correspondence (a first association) between one or more gNB-Tx(s) at the gNB side and one or more gNB-Rx(s) at the gNB side. The UE may transmit one or more random access preambles on a particular UE-TX using the selected one or more PRACHs.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

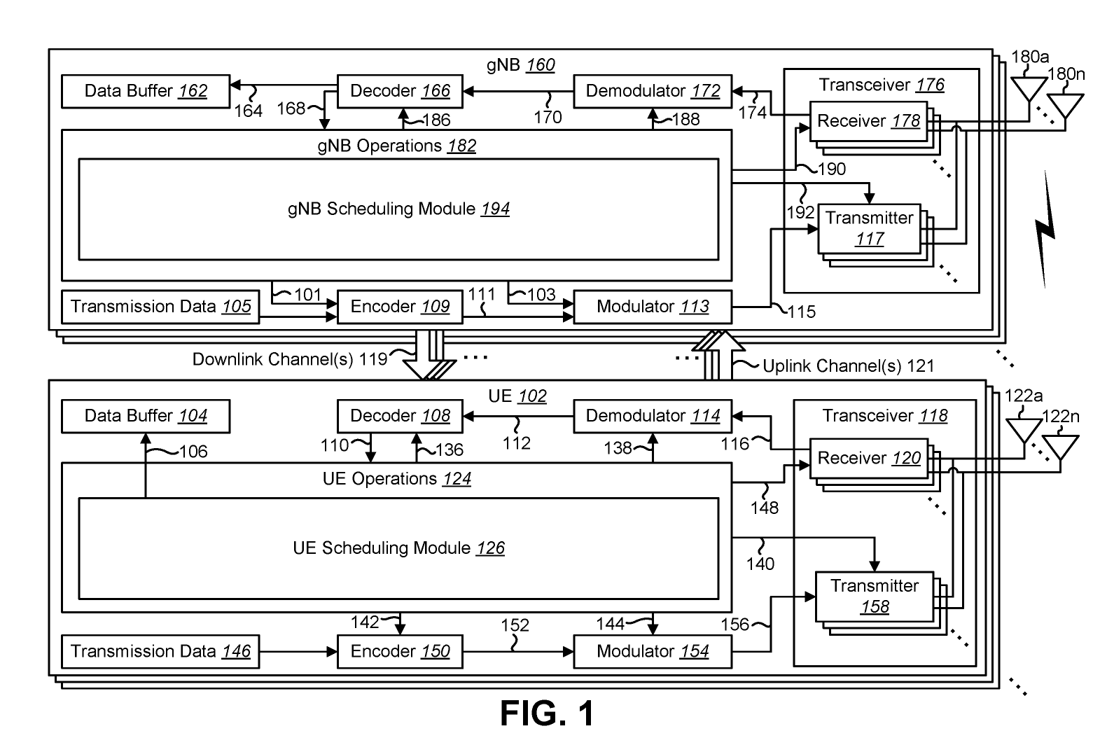

FIG. 1 is a block diagram illustrating one implementation of one or more gNBs 160 and one or more UEs 102 in which systems and methods for uplink transmission may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (Physical Uplink Shared Channel)) and/or a physical control channel (e.g., PUCCH (Physical Uplink Control Channel)), etc. The one or more gNBs 160 may also transmit information or data to the one or more UEs 102 using one or more downlink channels 119, for instance. Examples of downlink channels 119 physical shared channel (e.g., PDSCH (Physical Downlink Shared Channel) and/or a physical control channel (PDCCH (Physical Downlink Control Channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform uplink transmissions. The uplink transmissions include data transmission transmission) and/or uplink reference signal transmission.

In a radio communication system, physical channels (uplink physical channels and/or downlink physical channels) may be defined. The physical channels (uplink physical channels and/or downlink physical channels) may be used for transmitting information that is delivered from a higher layer.

For example, in uplink, a PRACH (Physical Random Access Channel) may be defined. For instance, the PRACH may be used for a random access preamble (e.g., a message 1 (Msg.1)). In some approaches, the PRACH may be used for an initial access connection establishment procedure, a handover procedure, a connection re-establishment, a timing adjustment (e.g., a synchronization for an uplink transmission) and/or for requesting an uplink shared channel (UL-SCH) resource (e.g., the uplink PSCH (e.g., PUSCH) resource).

In another example, a PCCH (Physical Control Channel) may be defined. The PCCH may be used to transmit control information. In uplink, PCCH (e.g., Physical Uplink Control Channel (PUCCH)) is used for transmitting Uplink Control Information (UCI). The UCI may include Hybrid Automatic Repeat Request (HARQ-ACK), Channel State information (CSI) and/or Scheduling Request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel. Also, the SR is used for requesting resources of uplink data (e.g., Transport block(s), MAC PDU and/or Uplink Shared Channel (UL-SCH)).

In downlink, the PCCH (e.g., Physical Downlink Control Channel (PDCCH)) may be used for transmitting Downlink Control Information (DCI). Here, more than one DCI format may be defined for DCI transmission on the PCCH. Namely, fields may be defined in the DCI format, and the fields are mapped to the information bits (e.g., DCI bits). For example, a DCI format 1A that is used for scheduling of one physical shared channel (PSCH) (e.g., PDSCH, transmission of one downlink transport block) in a cell is defined as the DCI format for the downlink.

Also, for example, a DCI format 0 that is used for scheduling of one PSCH (e.g., PUSCH, transmission of one uplink transport block) in a cell is defined as the DCI format for the uplink. For example, information associated with PSCH (a PDSCH resource, PUSCH resource) allocation, information associated with modulation and coding scheme (MCS) for PSCH, and DCI such as Transmission Power Control (TPC) command for PSCH and/or PCCH are included the DCI format. Also, the DCI format may include information associated with a beam index and/or an antenna port. The beam index may indicate a beam used for downlink transmissions and uplink transmissions. The antenna port may include DL antenna port and/or UL antenna port.

Also, for example, PSCH may be defined. For example, in a case that the downlink PSCH resource (e.g., PDSCH resource) is scheduled by using the DCI format, the UE 102 may receive the downlink data, on the scheduled downlink PSCH resource. Also, in a case that the uplink PSCH resource (e.g., PUSCH resource) is scheduled by using the DCI format, the UE 102 transmits the uplink data, on the scheduled uplink PSCH resource. Namely, the downlink PSCH is used to transmit the downlink data. And, the uplink PSCH is used to transmit the uplink data.

Furthermore, the downlink PSCH and the uplink PSCH are used to transmit information of higher layer (e.g., Radio Resource Control (RRC)) layer and/or MAC layer). For example, the downlink PSCH and the uplink PSCH are used to transmit RRC message (RRC signal) and/or MAC Control Element (MAC CE). Here, the RRC message that is transmitted from the gNB 160 in downlink may be common to multiple UEs 102 within a cell (referred as a common RRC message). Also, the RRC message that is transmitted from the gNB 160 may be dedicated to a certain UE 102 (referred as a dedicated RRC message). The RRC message and/or the MAC CE are also referred to as a higher layer signal.

In some approaches, the downlink PSCH (e.g., PDSCH) may be used for transmitting (e.g., notifying, specifying, identifying, etc.) a random access response. For example, the downlink PSCH (e.g., PDSCH) may be scheduled by using the downlink PCH (e.g., PDCCH) with RA-RNTI (Random Access RNTI). For instance, the random access response grant may be used for scheduling of the uplink PSCH (e.g., PUSCH). The random access response grant may be delivered from the higher layer (e.g., the MAC layer) to the physical layer.

In some approaches, as a message 2 (Msg.2) in a random access procedure, the gNB 160 may transmit a random access response including the random access response grant. For example, in the random access procedure, the gNB 160 may transmit the random access response (e.g., the random access response grant) that corresponds to a message 1 (Msg.1). The UE 102 may transmit, based on a random access configuration, a random access preamble as the Msg. 1. For example, in the random access procedure, the gNB 160 may transmit the random access response (the random access response grant) for transmitting a message 3 (Msg.3). In the random access procedure, the random access response grant may be used for scheduling of the uplink PSCH (e.g., PUSCH) for transmitting a Msg.3.

In some approaches, the random access configuration may include a physical random access channel configuration and/or the random access configuration. The random access configuration described herein may be assumed to be included in the physical random access channel configuration in some implementations for the sake of simple description.

In some approaches, a PBCH (Physical Broadcast Channel, (e.g., Primary PBCH)) may be defined. For example, the PBCH may be used for broadcasting the MIB (Master Information Block). For instance, the MIB may be used by multiple UEs 102 and may include system information transmitted on the BCH (Broadcast Channel). Also, the MIB may include information (e.g., an information block) for configuring a Secondary PBCH. Furthermore, the MIB may include information (e.g., an information block) for configuring the downlink PSCH (e.g., PDSCH). For example, the PBCH (e.g., MIB) may be used for carrying, at least, information indicating a SFN (System Frame Number).

The system information may be divided into the MIB and a number of SIB(s) (System Information Block(s)). The MIB may include a limited number of most essential and/or most frequently transmitted information (e.g., parameter(s)) that are needed to acquire other information from the cell. Namely, the PBCH (e.g., MIB) may include minimum system information. Also, the SIB(s) may be carried in a System Information message. For example, the SIB(s) may be transmitted on the Secondary PBCH and/or the downlink PSCH (e.g., PDSCH). The SIB(s) may include remaining minimum system information. For example, the SIB(s) (e.g., System Information Block Type 2) may contain radio resource configuration information that is common for multiple UEs 102.

In some approaches, the SIB(s) may contain information for a random access channel configuration (e.g., a random access configuration for a preamble format) that is used for a random access procedure (e.g., a random access preamble transmission (Msg.1 transmission)). For example, the information for the random access configuration may include the preamble format, SFN, a subframe number (e.g., a subframe number, a slot number and/or a symbol number). For instance, there may be at most one random access resource per subframe, slot and/or symbol. In particular, the time resources (the subframes, the slots and/or the symbols) and/or the frequency resources in which random access preamble transmission (e.g., Msg.1 transmission) is allowed may be given by the information for the random access configuration. The time resources and/or the frequency resources in which the random access preamble transmission (e.g., Msg.1 transmission) is allowed may be referred as a random access channel (RACH) transmission occasion herein. A part of the information for the random access configuration may be included in the MIB (e.g., PBCH).

In some approaches, in downlink, a SS (Synchronization Signal) may be defined. The SS may be used for synchronizing downlink time-frequency. The SS may include a PSS (Primary Synchronization Signal). Additionally or alternatively, the SS may include a SSS (Secondary Synchronization Signal). Additionally or alternatively, the SS may include a TSS (Tertiary Synchronization Signal). For example, the PSS, the SSS, the TSS and/or the PBCH may be used for identifying a physical layer cell identity. Additionally or alternatively, the PSS, the SSS, the TSS and/or the PBCH may be used for identifying an identity for one or more beams, one or more TRPs and/or one or more antenna ports. Additionally or alternatively, the PSS, the SSS, TSS and/or the PBCH may be used for identifying an OFDM symbol index, a slot index in a radio frame and/or a radio frame number.

In the radio communication for uplink, UL reference signal(s) (RS(s)) may be used as uplink physical signal(s). The uplink physical signal may not be used to transmit information that is provided from the higher layer, but is used by a physical layer. For example, the UL RS(s) may include the demodulation reference signal(s), the UE-specific reference signal(s), the sounding reference signal(s) and/or the beam-specific reference signal(s). The demodulation reference signal(s) may include demodulation reference signal(s) associated with transmission of uplink physical channel (e.g., PUSCH and/or PUCCH).

Also, the UE-specific reference signal(s) may include reference signal(s) associated with transmission of uplink physical channel (e.g., PUSCH and/or PUCCH). For example, the demodulation reference signal(s) and/or the UE-specific reference signal(s) may be a valid reference for demodulation of uplink physical channel only if the uplink physical channel transmission is associated with the corresponding antenna port. The gNB 160 may use the demodulation reference signal(s) and/or the UE-specific reference signal(s) to perform (re)configuration of the uplink physical channels. The sounding reference signal may be used to measure an uplink channel state.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time resources and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB scheduling module 194. The gNB scheduling module 194 may perform scheduling of uplink transmissions as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time resources and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

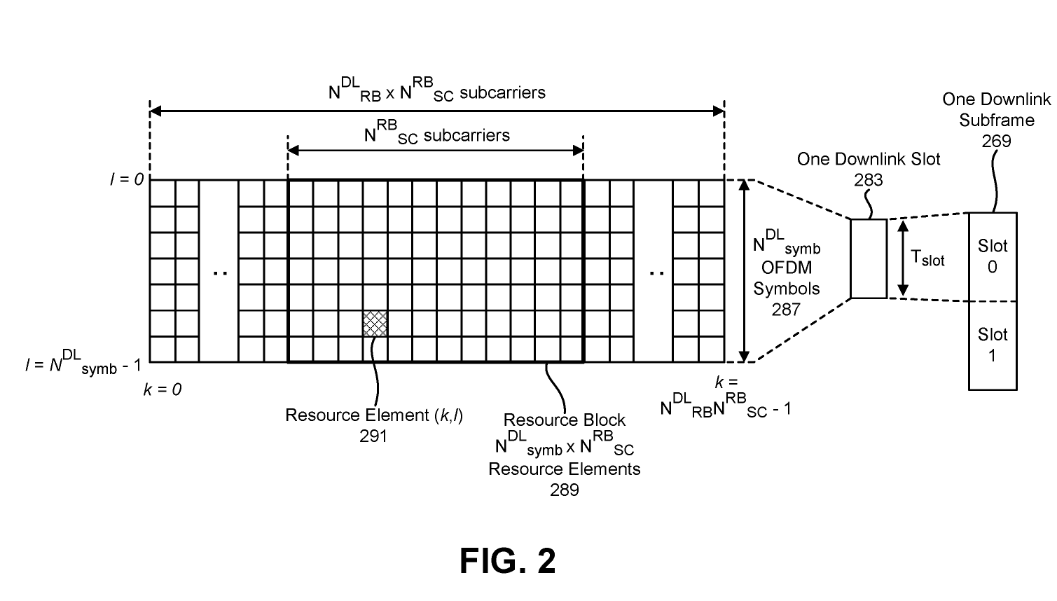

FIG. 2 is a diagram illustrating one example of a resource grid for the downlink. The resource grid illustrated in FIG. 2 may be utilized in some implementations of the systems and methods disclosed herein. More detail regarding the resource grid is given in connection with FIG. 1.

In FIG. 2, one downlink subframe 269 may include two downlink slots 283. N^{DL}_{RB} is downlink bandwidth configuration of the serving cell, expressed in multiples of N^{RB}_{sc}, where N^{RB}_{sc} is a resource block 289 size in the frequency domain expressed as a number of subcarriers, and N^{DL}_{symb} is the number of OFDM symbols 287 in a downlink slot 283. A resource block 289 may include a number of resource elements (RE) 291.

For a PCell, N^{DL}_{RB} is broadcast as a part of system information. For an SCell (including an Licensed Assisted Access (LAA) SCell), N^{DL}_{RB} is configured by a RRC message dedicated to a UE 102. For PDSCH mapping, the available RE 291 may be the RE 291 whose index 1 fulfils 1≥1_{data,start} and/or 1_{data,end}≥1 in a subframe.

In the downlink, the OFDM access scheme with cyclic prefix (CP) may be employed, which may be also referred to as CP-OFDM. In the downlink, PDCCH, enhanced PDCCH (EPDCCH), PDSCH and the like may be transmitted. A downlink radio frame may consist of multiple pairs of downlink resource blocks (RBs) which is also referred to as physical resource blocks (PRBs). The downlink resource block (RB) pair is a unit for assigning downlink radio resources, defined by a predetermined bandwidth (RB bandwidth) and a time slot. The downlink RB pair consists of two downlink RBs that are continuous in the time domain.

The downlink RB consists of twelve sub-carriers in the frequency domain and seven (for normal CP) or six (for extended CP) OFDM symbols in the time domain. A region defined by one sub-carrier in the frequency domain and one OFDM symbol in the time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs.

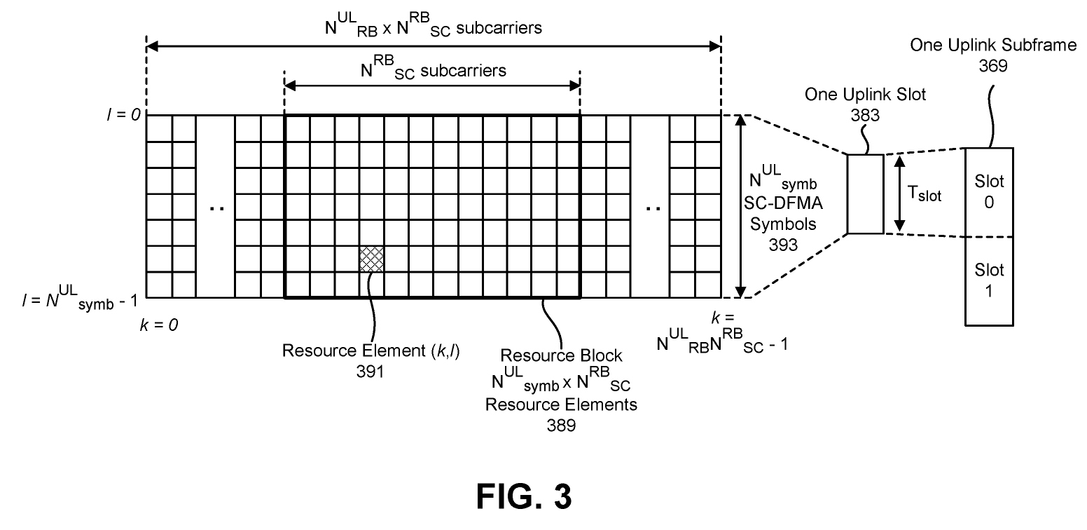

FIG. 3 is a diagram illustrating one example of a resource grid for the uplink. The resource grid illustrated in FIG. 3 may be utilized in some implementations of the systems and methods disclosed herein. More detail regarding the resource grid is given in connection with FIG. 1.

In FIG. 3, one uplink subframe 369 may include two uplink slots 383. N^{UL}_{RB} is uplink bandwidth configuration of the serving cell, expressed in multiples of N^{RB}_{sc}, where N^{RB}_{sc} is a resource block 389 size in the frequency domain expressed as a number of subcarriers, and N^{UL}_{symb} is the number of SC-FDMA symbols 393 in an uplink slot 383. A resource block 389 may include a number of resource elements (RE) 391.

For a PCell, N^{UL}_{RB} is broadcast as a part of system information. For an SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, physical random access channel (PRACH) and the like may be transmitted. An uplink radio frame may consist of multiple pairs of uplink resource blocks. The uplink RB pair is a unit for assigning uplink radio resources, defined by a predetermined bandwidth (RB bandwidth) and a time slot. The uplink RB pair consists of two uplink RBs that are continuous in the time domain.

The uplink RB may consist of twelve sub-carriers in the frequency domain and seven (for normal CP) or six (for extended CP) OFDM/DFT-S-OFDM symbols in the time domain. A region defined by one sub-carrier in the frequency domain and one OFDM/DFT-S-OFDM symbol in the time domain is referred to as a resource element (RE) and is uniquely identified by the index pair (k,l) in a slot, where k and l are indices in the frequency and time domains respectively. While uplink subframes in one component carrier (CC) are discussed herein, uplink subframes are defined for each CC.

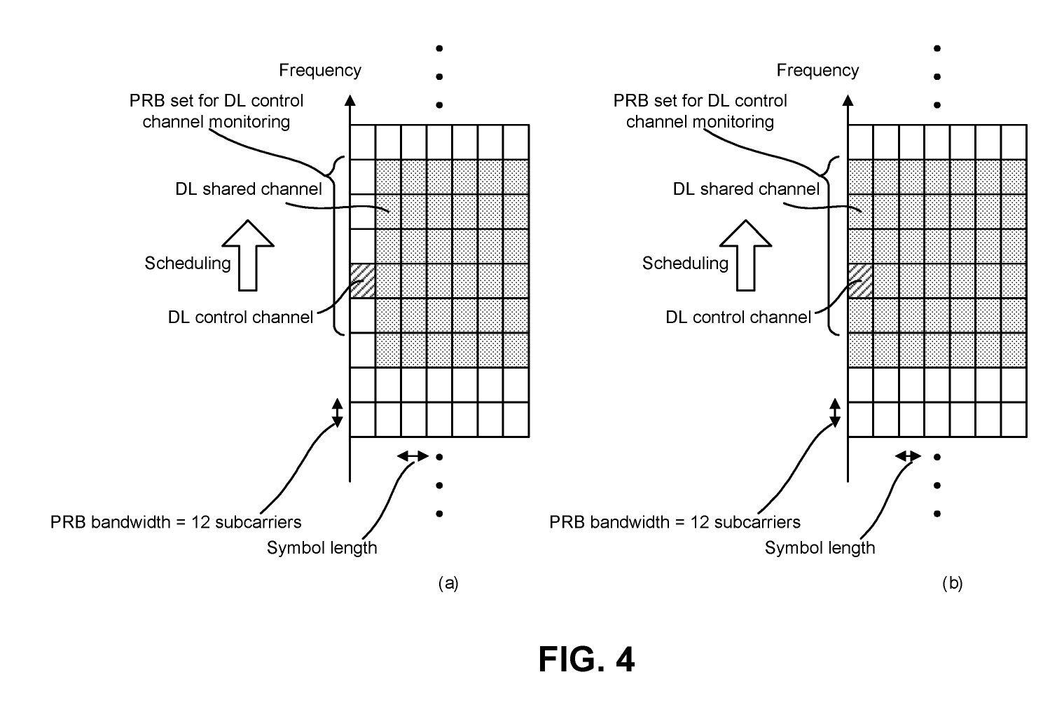

FIG. 4 shows examples of DL control channel monitoring regions. One or more sets of PRB(s) may be configured for DL control channel monitoring. In other words, a control resource set is, in the frequency domain, a set of PRBs within which the UE 102 attempts to blindly decode downlink control information (e.g., monitor downlink control information (DCI)), where the PRBs may or may not be frequency contiguous, a UE 102 may have one or more control resource sets and one DCI message may be located within one control resource set. In the frequency-domain, a PRB is the resource unit size (which may or may not include DM-RS) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

Namely, the UE 102 may monitor a set of PCCH (e.g., PDCCH) candidates. Here, the PCCH candidates may be candidates for which the PCCH may possibly be assigned and/or transmitted. A PCCH candidate is composed of one or more control channel elements (CCEs). The term “monitor” means that the UE 102 attempts to decode each PDCCH in the set of PDCCH candidates in accordance with all the DCI formats to be monitored.

The set of PDCCH candidates that the UE 102 monitors may be also referred to as a search space. That is, the search space is a set of resource that may possibly be used for PCCH transmission.

Furthermore, a common search space (CSS) and a user-equipment search space (USS) are set (or defined, configured) in the PCCH resource region. For example, the CSS may be used for transmission of DCI to a plurality of the UEs 102. That is, the CSS may be defined by a resource common to a plurality of the UEs 102. For example, the CSS is composed of CCEs having numbers that are predetermined between the gNB 160 and the UE 102. For example, the CSS is composed of CCEs having indices 0 to 15.

Here, the CSS may be used for transmission of DCI to a specific UE 102. That is, the gNB 160 may transmit, in the CSS, DCI format(s) intended for a plurality of the UEs 102 and/or DCI format(s) intended for a specific UE 102.

The USS may be used for transmission of DCI to a specific UE 102. That is, the USS is defined by a resource dedicated to a certain UE 102. That is, the USS may be defined independently for each UE 102. For example, the USS may be composed of CCEs having numbers that are determined based on a Radio Network Temporary Identifier (RNTI) assigned by the gNB 160, a slot number in a radio frame, an aggregation level, or the like.

Here, the RNTI(s) may include C-RNTI (Cell-RNTI), RA-RNTI (Random Access-RNTI) and/or Temporary C-RNTI. For example, C-RNTI may be a unique identification used for identifying RRC connection and scheduling. The RA-RNTI may be an identification used for the random access procedure. The Temporary C-RNTI may be used for the random access procedure. Also, the USS (the position(s) of the USS) may be configured by the gNB 160. For example, the gNB 160 may configure the USS by using the RRC message. That is, the base station may transmit, in the USS, DCI format(s) intended for a specific UE 102.

Here, the RNTI assigned to the UE 102 may be used for transmission of DCI (transmission of PCCH). Specifically, CRC (Cyclic Redundancy Check) parity bits (also referred to simply as CRC), which are generated based on DCI (or DCI format), are attached to DCI, and, after attachment, the CRC parity bits are scrambled by the RNTI. The UE 102 may attempt to decode DCI to which the CRC parity bits scrambled by the RNTI are attached, and detects PCCH (e.g., DCI, DCI format). That is, the UE 102 may decode PCCH with the CRC scrambled by the RNTI. For example, the downlink PCCH (e.g., PDCCH), to which CRC parity bits scrambled by RA-RNTI are attached, may be used for scheduling of the downlink PSCH (e.g., PDSCH (e.g., Msg.2) transmission). Additionally or alternatively, the downlink PCCH (e.g., PDCCH), to which CRC parity bits scrambled by Temporary C-RNTI are attached, may be used for scheduling the uplink PSCH (e.g., PUSCH (e.g., Msg.3) retransmission).

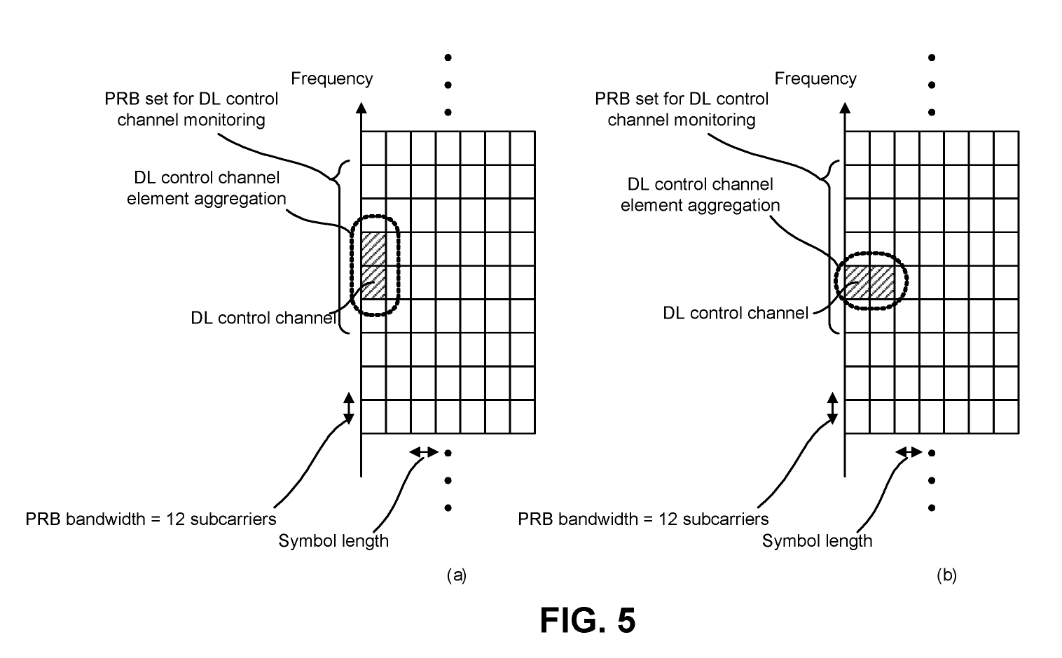

FIG. 5 shows examples of DL control channels, which may include more than one control channel element. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

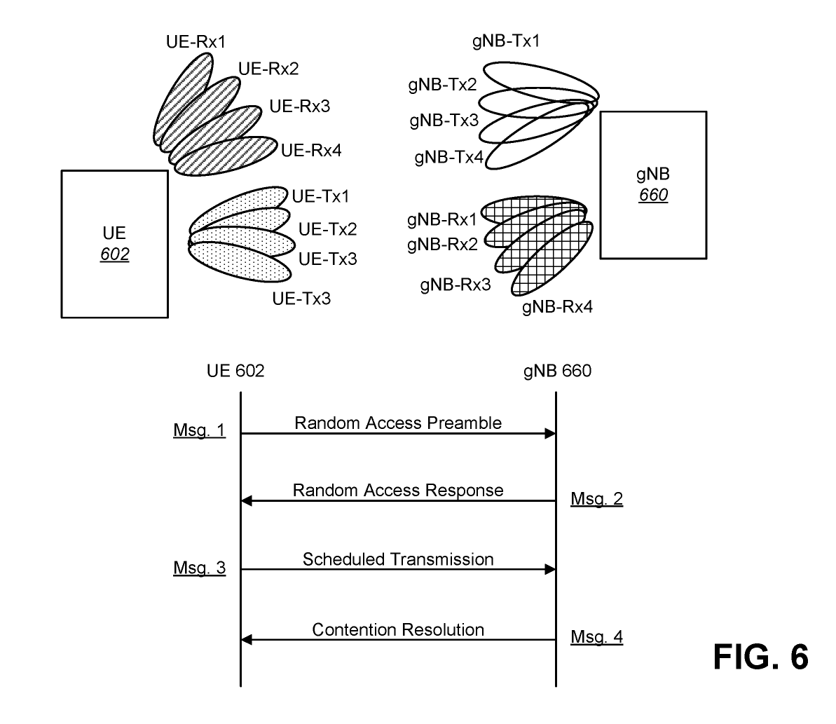

FIG. 6 shows examples of communications between the gNB 660 and the UE 602. For example, the gNB 660 may communicate with the UE 602 using single-beam and/or multi-beam operations (e.g., by using a beam sweeping). In some approaches, the UE 602 may communicate with the gNB 660 using single-beam and/or multi-beam operation. The beam(s) may be associated with the antenna port(s) and/or the TRP(s). For example, the beam(s) may be defined by using the antenna port(s) and/or the TRP(s). For instance, one or more beams may be associated with one or more antenna ports and/or one or more TRPs. Also, there may be a transmission beam at the gNB 660 side (gNB-Tx) that is used for transmission of downlink signal (e.g., Synchronization Signal, PBCH (MIB), Secondary PBCH, PDCCH (DCI) and/or PDSCH (downlink data)). Additionally or alternatively, there may be a reception beam at the UE 602 side (UE-Rx) that is used for reception of the downlink signal. Additionally or alternatively, there may be a transmission beam at the UE 602 (UE-Tx) that is used for transmission of uplink signal (e.g., PRACH, PUSCH (uplink data) and/or PUCCH (UCI)). Also, there may be a reception beam at the gNB side (gNB-Rx) that is used for reception of the uplink signal.

In some approaches, there may be a first correspondence (e.g., a first pair, a first association, a first link, etc.) between a transmission beam at the gNB 660 side and a reception beam at the gNB 660 side. For example, there may be a reciprocity between a transmission beam at the gNB 660 side and a reception beam at the gNB 660 side. For instance, the gNB-Tx1 may be associated with the gNB-Rx1, the gNB-Tx2 may be associated with the gNB-Rx2, the gNB-Tx3 may be associated with the gNB-Rx3 and the gNB-Tx4 may be associated with the gNB-Rx4 (e.g., a one-to-one first correspondence). In another example, the gNB-Tx1 may be associated with the gNB-Rx1 and the gNB-Rx2 (e.g., a one-to-many first correspondence). In yet another example, the gNB-Tx3 and the gNB-Tx4 may be associated with the gNB-Rx3 and the gNB-Rx4 (e.g., a many-to-many first correspondence).

Additionally or alternatively, there may be a second correspondence (e.g., a second pair, a second association, a second link, etc.) between a transmission beam at the gNB 660 side and a reception beam at the UE 602 side. For example, the gNB-Tx1 may be associated with the UE-Rx1 (e.g., a one-to-one second correspondence). In another example, the gNB-Tx1 may be associated with the UE-Rx1 and the UE-Rx2 (e.g., a one-to-many second correspondence). In yet another example, the gNB-Tx1 and the gNB-Tx2 may be associated with the UE-Rx1 and the UE-Rx2 (e.g., a many-to-many second correspondence).

Additionally or alternatively, there may be a third correspondence (e.g., a third pair, a third association, a third link, etc.) between a transmission beam at the UE 602 side and a reception beam at the gNB 660 side. For example, the UE-Tx1 may be associated with the gNB-Rx1 (e.g., a one-to-one third correspondence). In another example, the UE-Tx1 may be associated with the gNB-Rx1 and the gNB-Rx2 (e.g., a one-to-many third correspondence). In yet another example, the UE-Tx1 and the UE-Tx2 may be associated with the gNB-Rx1 and the gNB-Rx3 (e.g., a many-to-many third correspondence).

Here, the gNB 660 and/or the UE 602 may transmit each information that is used for configuring each correspondence (e.g., each of the first correspondence, the second correspondence and/or the third correspondence). For example, the information used for configuring the correspondence may be identified by using the PSS, the SSS and/or the TSS. In some approaches, the information used for configuring the correspondence may be carried by using the PBCH, the Secondary PBCH, the PDSCH and/or the dedicated RRC message.

Here, for example, for an idle mode UE 602, information included in the MIB may be used for configuration(s). Additionally or alternatively, for a connected mode UE 602, information included in the dedicated RRC message may be used for configuration(s).

In some approaches, a random access procedure may be performed between the gNB 660 and the UE 602. For example, the random access procedure may include a contention based random access procedure and a non-contention based random access procedure. For instance, the random access procedure may include a 4-step random access procedure and a 2-step random access procedure. FIG. 6 illustrates an example of a 4-step contention based random access procedure.

In a case that the 2-step random access procedure is performed, a concurrent (e.g., simultaneous) transmission of a PRACH (e.g., the Msg.1) and a PUSCH (e.g., the Msg.3) may be configured by the gNB 660. For example, the gNB 660 may transmit the dedicated RRC message including information used for configuring the simultaneous transmission of PRACH and PUSCH. For example, the UE 602 may perform the 2-step random access procedure in a case that the concurrent transmission of the PRACH and the PUSCH is configured. And, the UE 602 may switch the 4-step random access procedure and the 2-step random access procedure based on whether the simultaneous transmission of the PRACH and the PUSCH is configured or not. Here, in a case of the 2-step random access procedure, the Msg.2 and the Msg.4 may be combined and transmitted to the UE 602.

In some approaches, in a random access procedure initialization, one or more of the following information given in Listing (1) for related Serving Cell may be assumed to be available for the UE 602 before the procedure can be initiated. For example, one or more of the following information given in Listing (1) may be included in the information for the random access configuration. Additionally or alternatively, one or more of the following information given in Listing (1) may be identified by using the PSS, the SSS and/or the TSS. Additionally or alternatively, one or more of the following information given in Listing (1) may be included in the MIB, the SIB(s) and/or the dedicated RRC message.
The available set of PRACH resources for the transmission of the ransom access preamble (e.g., PRACH configuration). For example, the PRACH resources may include the time resources, the frequency resources, the preamble formats and/or code resources (e.g., sequences). For instance, the gNB 602 may configure one or more PRACH resources that correspond to the gNB-Rx (e.g., the number of the gNB-Rx), as the available set of PRACH resources. In particular, one or more PRACH resources may be configured by using the information for the random access configuration. Additionally or alternatively, one or more PRACH resources may be identified by using the PSS, the SSS and/or the TSS. Additionally or alternatively, one or more PRACH resources may be configured by using the information included in the MIB, the SIB(s) and/or the dedicated RRC message.
The groups of random access preambles and the set of available random access preambles in each group. For example, the each group may be associated with the downlink signal(s) (e.g., PSS, SSS, TSS, PBCH, Secondary PBCH and/or PDSCH). Additionally or alternatively, each group may associated with the gNB-Tx and/or the UE-Rx. Additionally or alternatively, each group may be associated with the gNB-Rx and/or the UE-Tx.
The RA response window size
The power-ramping factor (e.g., a step for the power-ramping)
The maximum number of preamble transmission
The initial preamble power
The preamble format (e.g., the PRACH preamble format) Listing (1)

In some approaches, the UE 602 may transmit the random access preamble (Msg.1) based on one or more of the above information given in Listing (1). Additionally or alternatively, the UE may receive the random access response (Msg.2) based on one or more of the above information given in Listing (1). Additionally or alternatively, the UE 602 may perform a scheduled UL-SCH transmission (Msg.3) based on one or more of the above information given in Listing (1). Additionally or alternatively, the UE may receive the contention resolution (Msg.4) based on one or more of the above information.

In some approaches in Random Access Resource selection (e.g., PRACH selection), the UE 602 may select (e.g., determine) one or more random access preambles. Additionally or alternatively, the UE 602 may select (e.g., determine) one or more groups of the random access preamble. Additionally or alternatively, the UE 602 may select (e.g., determine) one or more PRACH resources (e.g., PRACH time-frequency resources (e.g., PRACH time resources and/or PRACH frequency resources)). For example, the UE 602 may select (e.g., determine) one or more PRACH time resources and/or one or more PRACH frequency resources based on the PRACH configuration index. Additionally or alternatively, the UE may select (e.g., determine) one or more PRACH configuration indexes. The selection (e.g., the determination) of one or more PRACHs may include the selection (e.g., the determination) of the one or more random access preambles, the selection (e.g., the determination) of the one or more groups of the random access preambles, the selection (e.g., the determination) of the one or more PRACH time-frequency resources (e.g., PRACH time resources and/or PRACH frequency resources) and/or the selection (e.g., the determination) of the one or more PRACH configuration indices.

In some examples, the UE 602 may randomly select the one or more PRACHs. Additionally or alternatively, the UE 602 may select the one or more PRACHs based on the received downlink signal(s) (e.g., PSS, SSS, TSS, PBCH, Secondary PBCH and/or PDSCH). Additionally or alternatively, the UE 602 may select the one or more PRACHs based on the downlink reference signal(s) (e.g., reference signal(s) associated with a measurement(s) and/or reference signal(s) associated with a beam transmission(s)). For example, the UE 602 may select the one or more PRACHs based on a measurement of the received downlink signal(s) and/or the downlink reference signal(s).

More specifically, for example, the UE 602 may receive the information used for configuring (identifying) the one or more PRACHs, and may select the one or more PRACHs within the configured (e.g., identified) one or more PRACHs. The UE may perform the random access procedure based on the selected one or more random access PRACHs. Some details of processes and/or procedures for the selection of the one or more PRACHs are described below.

In some approaches in random access preamble transmission, the UE 602 may transmit the random access preamble (Msg.1) using the selected one or more PRACHs. Additionally or alternatively, the UE 602 may transmit the random access preamble (Msg.1) with the number of repetitions corresponding to the determined number. Some details of processes and/or procedures for the determination of the repeated number are described blow. In some approaches, the random access preamble(s) may be identified by one or more random access preamble identifiers. For example, the UE 602 may perform a single Msg.1 transmission before the end of a monitored the RA response window. Additionally or alternatively, the UE 602 may transmit multiple Msg.1 transmissions until the end of the RA response window.

Additionally or alternatively, in random access response reception, the UE 602 may receive the random access response (Msg.2). For example, once the random access preamble is transmitted, the UE 602 may monitor the downlink PCCH (e.g., PDCCH) for the random access response(s) identified by the RA-RNTI in the RA Response window. A size of the RA Response window (e.g., a duration in which the UE 602 monitors the PDCCH with the RA-RNTI) may be configured by using the information of the RA response window size. Additionally or alternatively, a single RA response window may be used (e.g., a single RA response window size may be configured) for the single Msg.1 transmission and/or the multiple Msg.1 transmissions. Additionally or alternatively, multiple RA response windows may be used (e.g., multiple RA response window sizes may be configured) for the multiple Msg.1 transmissions.

In some approaches, RA-RNTI associated with the PRACH (e.g., the selected one or more PRACHs), in which the random access preamble is transmitted, may be computed as: RA-RNTI=1+t_id+10*f_id. Additionally or alternatively, the RA-RNTI associated with the PRACH, in which the random access preamble is transmitted, may be computed as: RA-RNTI=1+t_id+10*f_id+x_id. Additionally or alternatively, the RA-RNTI associated with the PRACH, in which the random access preamble is transmitted, may be computed as: RA-RNTI=x_id. Here, t_id may be a time index of the PRACH. The time index of the PRACH may be include a time index of the first subframe, the first slot and/or the first symbol (e.g., RACH symbol) for the PRACH. Also, f_id may be a frequency index of the PRACH. The frequency index of the PRACH may include a frequency index of the PRACH within (e.g., corresponding to) the time index. Also, x_id may be an index associated with the PRACH. For example, the index associated with the PRACH may include an index of the UE-Tx. Also, for example, the index associated with the PRACH may include an index of the RACH transmission occasion. Also, for example, the index associated with the PRACH may be identified (e.g., computed) by using the PSS, the SSS, the TSS, the information included in the MIB, the information included in the SIB(s) and/or the information included in the dedicated RRC message.

The RACH transmission occasion may be defined as the time-frequency resources (e.g., the time resources and/or the frequency resources) on which a PRACH message 1 is transmitted using the configured PRACH preamble format (e.g., the configured PRACH preamble format with a single particular UE-Tx). The random access preamble format may include one or multiple random access preambles. Additionally or alternatively, the random access preamble may include one preamble sequence plus CP (Cyclic Prefix). Additionally or alternatively, one preamble sequence may include one ore multiple RACH symbols (e.g., RACH OFDM (Orthogonal Frequency Division Multiplexing) symbols). For example, the UE 602 may transmit the PRACH according to the configured random access preamble format. For instance, the UE 602 may transmit the random access preamble (e.g., the selected one or more random access preambles) using the selected PRACH resources (e.g., the selected one or more PRACH resources).

The UE 602 may stop monitoring for the random access response(s) after successful reception of a random access response containing the one or more random access preamble identifiers that match the transmitted random access preamble. Additionally or alternatively, for example, if no random access response is received with a RA response window given by the RA response window size, the random access response reception may be considered unsuccessful, and the UE 602 may perform a process for the power-ramping based on the power-ramping factor. Then, the UE 602 may proceed to perform the selection of PRACHs. For example, the RA response may contain the one or more random access preamble identifiers. Additionally or alternatively, the RA response may contain the index of the RACH transmission occasion (e.g., a time index of the RACH transmission occasion). Additionally or alternatively, the RA response may contain the index of the random access preamble transmission (e.g., a time index of the random access preamble transmission). Additionally or alternatively, the RA response may contain a Timing Advance Command, the random access response grant and/or the Temporary C-RNTI. Additionally or alternatively, the RA response may contain information used for indicating quality information (e.g., information used for indicating quality information of the random access preamble transmission (e.g., the Msg.1 transmission)).

Additionally or alternatively, the RA response may contain the power-ramping factor. For example, in a case that the power-ramping factor is included in the RA response (e.g., a value for the step size for the power-ramping is set to a field of the power-ramping factor), the UE 602 may perform the process for the power-ramping and transmit the power-ramped random access preamble (e.g., perform the power-ramped Msg.1 transmission). Additionally or alternatively, the RA response may contain information used for indicating a grant for the Msg.3 transmission based on the random access response grant. For example, the UE 602 may perform the Msg.3 transmission based on the random access response grant in a case that the information indicates that the Msg.3 transmission is granted. Additionally or alternatively, the UE 602 may not perform the Msg.3 transmission based on the random access response grant in a case that the information does not indicate that the Msg.3 transmission is granted.

The power-ramping factor (e.g., the field of the power-ramping factor) may be used for (e.g., reused for) a field of the information indicating that the Msg.3 transmission is granted. For example, the UE 602 may switch the interpretation for the field of the power-ramping factor to the field of information indicating that the Msg.3 transmission is granted. For instance, in a case that the field of the power-ramping factor is set to “the value indicating the step size for the power-ramping,” the UE 602 may perform the power-ramping for the random access preamble transmission. In a case that the field of the power-ramping factor is set to “0” (e.g., the value indicating the step size for the power-ramping is “0”), for example, the UE 602 may perform the Msg.3 transmission. In a case that the field of the power-ramping factor is set to “a predetermined value,” the UE 602 may perform the Msg.3 transmission in some approaches. The predetermined value may be defined, in advance, by the specifications, and may be known information between the gNB 660 and the UE 602.

In some approaches, a field of the random access response grant may be replaced by the field of the power-ramping factor. For example, in a case that the field of the power-ramping factor is included in the RA access response, the UE 602 may perform the power-ramping for the random access preamble transmission and transmit the power-ramped random access preamble. Additionally or alternatively, in a case that the field of the random access response grant is included in the RA response, the UE 602 may perform the Msg.3 transmission based on the random access response grant.

Additionally or alternatively, in scheduled transmission, the UE 602 may perform a timing adjustment for the uplink transmission based on the timing advance command and/or may perform the Msg.3 transmission based on the random access response grant. For example, the UE 602 may receive the random access response on DL-SCH (e.g., the downlink PSCH (e.g., PDSCH)) that is scheduled by using the downlink PCCH (e.g., PDCCH) with RA-RNTI. Here, the Msg.3 transmission may include an identity used for identifying the UE 602 (Initial UE-Identity or C-RNTI). Additionally or alternatively, the UE 602 may perform the Msg.3 retransmission in a case that the Msg.3 retransmission is indicated by using PDCCH with the Temporary C-RNTI.

In some approaches in Contention Resolution, in a case that a contention resolution identity received from the gNB 660 is matched to the Initial UE-Identity, the UE 602 may consider the contention resolution successful. Additionally or alternatively, in a case that the downlink PCCH (e.g., PDCCH) with C-RNTI is received, the UE may consider the contention resolution successful. Then, the UE may consider the random access procedure successfully completed.

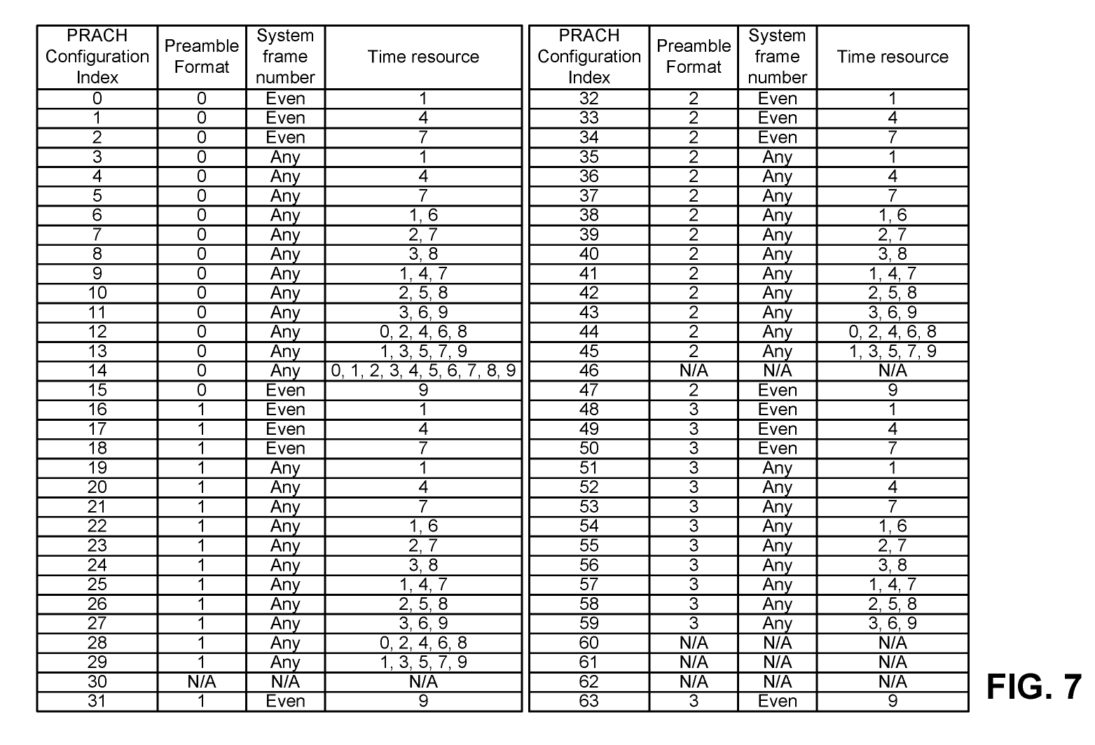

FIG. 7 is a table illustrating an example of a random access configuration. As described above, a UE (e.g., UE 102, 602, etc.) may select (e.g., determine) one or more random access preambles. Additionally or alternatively, the UE may select (e.g., determine) one or more groups of the random access preambles. Additionally or alternatively, the UE may select (e.g., determine) one or more PRACH resources (e.g., PRACH time-frequency resources (e.g., PRACH time resources and/or PRACH frequency resources)). For example, the UE may select (e.g., determine) one or more PRACH time resources and/or one or more PRACH frequency resources based on the PRACH configuration index. Additionally or alternatively, the UE may select (e.g., determine) one or more PRACH configuration indexes. The selection (e.g., determination) of one or more PRACHs may include the selection (e.g., determination) of the one or more random access preambles, the selection (e.g., determination) of the one or more groups of the random access preambles, the selection (e.g., determination) of the one or more PRACH time-frequency resources (e.g., PRACH time resources and/or PRACH frequency resources), and/or the selection (e.g., determination) of the one or more PRACH configuration indices. For example, the UE 602 may receive the information used for configuring (e.g., identifying) the one or more PRACHs, and select the one or more PRACHs within the configured (e.g., identified) one or more PRACHs. The UE may perform the random access procedure based on the selected one or more random access PRACHs. In some approaches, the UE 602 may randomly select the one or more PRACHs.

For example, 64 kinds of PRACH configuration indices (e.g., sequences) may be defined. Each PRACH configuration index may correspond to the preamble format, the SFN (System Frame Number) and/or the time resource number (e.g., subframe number, slot number and/or symbol number (PRACH symbol number)). For instance, as mentioned above, the one or more PRACH resources may configured (e.g., identified) as the available set of PRACH resources for the transmission of the random access preamble and the UE (e.g., UE 102, 602, etc.) may select the one or more PRACHs.

For example, the PRACH configuration indices “0,” “1,” “2,” and “8” may be configured and the UE may select the PRACH configuration index “2” in a case that the selection of one PRACH is determined. In another example, the PRACH configuration indices “0,” “1,” “2,” and “8” may be configured and the UE may select the PRACH configuration indices “0” and “2” in a case that the selection of two PRACHs is determined. In yet another example, the PRACH configuration indices “0,” “1,” “2,” and “8” may be configured and the UE may select the PRACH configuration indices “0,” “1,” “2,” and “8” in a case that the selection of four PRACHs is determined. In these cases, the preamble format used for the random access preamble may be the same (e.g., the preamble format is “0”). And, the preamble format used for the random access preamble may be different.

In one example, the time resources “0,” “2,” “4,” “6” and “8” in the PRACH configuration index “12” may be configured and the UE may select the time resource “4” in a case that the selection of one PRACH is determined. Here, the time resources “0,” “2,” “4,” “6” and “8” may be the PRACH time-frequency resources (e.g., the PRACH time resources and/or the PRACH frequency resources). The time resources “0,” “2,” “4,” “6” and “8” in the PRACH configuration indices “12” may be configured and the UE may select the time resources “0” and “4” in a case that the selection of two PRACHs is determined. Also, the time resources “0,” “2,” “4,” “6” and “8” in the PRACH configuration indices “12” may be configured and the UE may select the time resources “2,” “4,” “6” and “8” in a case that the selection of four PRACHs is determined. In these cases, the preamble format used for the random access preamble may be the same (e.g., the preamble format is “0”). The preamble format used for the random access preamble may be different.

As described above, the selection of the one or more PRACHs may be determined based on the measurement(s) of the downlink signal(s) and/or the downlink reference signal(s). For example, in a case that the selection of one PRACH is determined, the UE may select the PRACH configuration index “2” based on the measurement(s) of the downlink signal(s) and/or the downlink reference signal(s). For instance, each of the PRACH configuration indices may be associated with each of the PSSs and/or the SSSs and/or the TSSs, and the UE may select the PRACH configuration index “2” corresponding to a particular PSS and/or a particular SSS and/or a particular TSS. In a case that the selection of one PRACH is determined, the UE may select the time resource “4” based on the measurement(s) of the downlink signal(s) and/or the downlink reference signal(s). For example, each of the time resources may be associated with each of the PSSs and/or the SSSs and/or the TSSs, and the UE may select the time resource “4” corresponding to a particular PSS and/or a particular SSS and/or a particular TSS.

In some approaches, the downlink signal(s) and/or the downlink reference signal(s) may be used for indicating (e.g., identifying) the one or more PRACHs. For example, the UE may select the PRACH configuration index “2” that is indicated by using the downlink signal(s) and/or the downlink reference signal(s). Also, the UE may select the PRACH configuration indices “0” and “2” that are indicated by using the downlink signal(s) and/or the downlink reference signal(s). Also, the UE may select the PRACH configuration indices “0,” “1,” “2,” and “8” that are indicated by using the downlink signal(s) and/or the downlink reference signal(s). In these cases, the preamble format used for the random access preamble may be the same (e.g., the preamble format is “0”). The preamble format used for the random access preamble may be different.

In some approaches, the downlink signal(s) and/or the downlink reference signal(s) may be used for indicating (identifying) the one or more PRACHs. For example, the UE may select the time resource “4” that is indicated by using the downlink signal(s) and/or the downlink reference signal(s). In another example, the UE may select the time resources “0” and “4” that are indicated by using the downlink signal(s) and/or the downlink reference signal(s). In yet another example, the UE may select the time resources “2,” “4,” “6” and “8” that are indicated by using the downlink signal(s) and/or the downlink reference signal(s).

In the case mentioned above, the preamble format used for the random access preamble may be the same (e.g., the preamble format is “0”). The preamble format used for the random access preamble may be different.

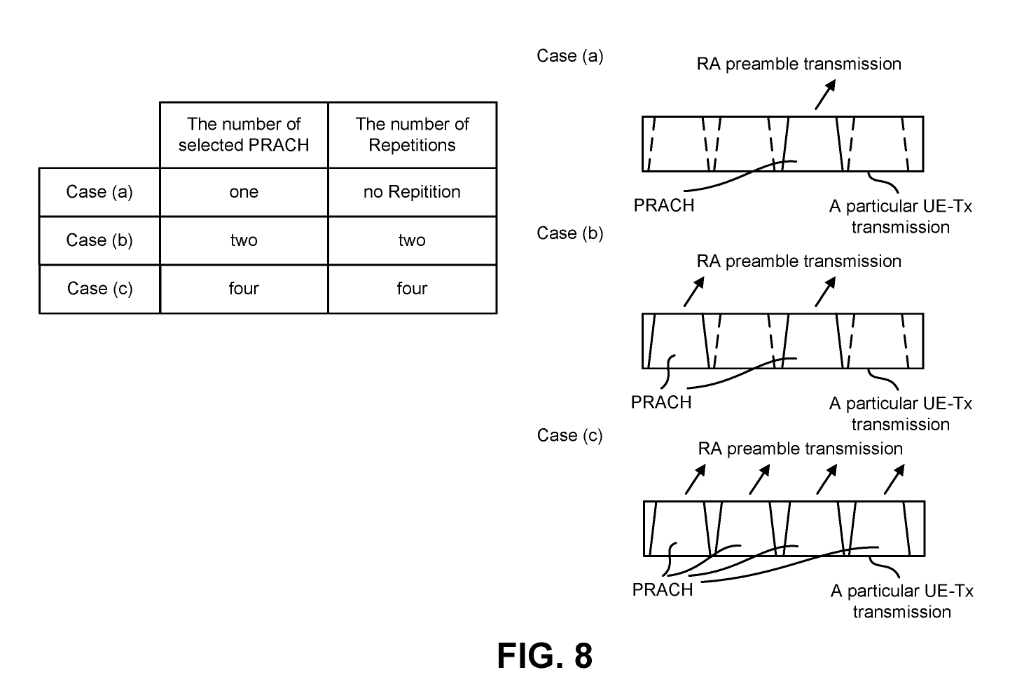

FIG. 8 shows an example of a random access procedure. In FIG. 8, as an example, the gNB-Tx1, the gNB-Tx2, the gNB-Tx3, the gNB-Tx4, the gNB-Rx1, the gNB-Rx2, the gNB-Rx3 and the gNB-Tx4 are assumed at the gNB side. Also, the UE-Tx1, the UE-Tx2, the UE-Tx3, the UE-Tx4, the UE-Rx1, the UE-Rx2, the UE-Rx3 and the UE-Rx4 are assumed at the UE side. As described above, the UE (e.g., UE 102, 602, etc.) may select the one or more PRACHs (e.g., the one or more PRACH resources).

For example, in case (a) in FIG. 8, where the gNB-Tx1 is associated with the gNB-Rx1, the gNB-Tx2 is associated with the gNB-Rx2, the gNB-Tx3 is associated with the gNB-Rx3 and the gNB-Tx4 is associated with the gNB-Rx4, the UE may select one PRACH. In case (a), the UE may perform one random access preamble transmission on a particular UE-Tx. For example, the UE may not repeat the random access preamble transmission on a particular UE-Tx. Additionally or alternatively, the UE may perform one random access preamble transmission in the RACH transmission occasion. For example, the UE may perform the Msg.1 transmission on each UE-Tx (e.g., the UE-Tx1, the UE-Tx2, the UE-Tx3 and/or the UE-Tx4) using the selected one PRACH. Here, as mentioned above, the one PRACH selected by the UE may be determined based on the measurement of the downlink signal(s) and/or the downlink reference signal(s).

In another example, in case (b) in FIG. 8, where the gNB-Tx1 and/or gNB-Tx3 is associated with the gNB-Rx1 and/or the gNB-Rx3 and the gNB-Tx2 and/or the gNB-Tx4 may be associated with the gNB-Rx2 and/or the gNB-Rx4, the UE may select two PRACHs. In case (b), the UE may perform the two random access preamble transmissions on a particular UE-Tx. Namely, the UE may perform two repetitions of the random access preamble transmission on a particular UE-Tx. Additionally or alternatively, the UE may perform the two repetitions of the random access preamble transmission in the RACH transmission occasion. For example, the UE may perform the Msg.1 transmission on each UE-Tx (e.g., the UE-Tx1, the UE-Tx2, the UE-Tx3 and/or the UE-Tx4) using the selected two PRACHs. As described above, the two PRACHs selected by the UE may be determined based on the measurement of the downlink signal(s) and/or the downlink reference signal(s).

For example, in case (b), the UE (e.g., UE 102, 602, etc.) may perform two random access preamble transmissions on each UE-Tx using the selected two PRACHs. In some approaches, the UE may use the selected two PRACHs during the two random access preamble transmissions on a particular UE-Tx. For example, the UE may use the first of the selected two PRACHs during the two random access preamble transmissions on the UE-Tx1, and use the second of the selected two PRACHs during the same two random access preamble transmissions on the UE-Tx1. Additionally or alternatively, the UE may use the first of the selected two PRACHs during the two random access preamble transmissions on the UE-Tx3, and use the second of the selected two PRACHs during the same two random access preamble transmissions on the UE-Tx3. For example, the UE may use all of the selected two PRACHs (e.g., the first and the second of the selected PRACHs) during the two random access preamble transmissions (e.g., the two random access preamble transmissions on a particular UE-Tx).

Additionally or alternatively, for example, in case (b), the UE may perform the two random access preamble transmissions on each set (e.g., each group) of the UE-Tx(s) (e.g., a first set of the UE-Tx1 and the UE-Tx3, and a second set of the UE-Tx2 and the UE-Tx4) using the selected two PRACHs. For example, the UE may use the selected two PRACHs for the two random access preamble transmissions on each UE-Tx. In some approaches, the UE may use the same PRACH(s) (e.g., the same two PRACHs) during the two random access preamble transmissions on a particular UE-Tx. For example, in case (b), the UE may use the first of the selected two PRACHs for the first of the two random access preamble transmissions on the UE-Tx1 and/or the UE-Tx3, and use the same first of the selected two PRACHs for the second of the same two random access preamble transmissions on the UE-Tx1 and/or the UE-Tx3. Additionally or alternatively, the UE may use the second of the selected two PRACHs for the first of the two random access preamble transmissions on the UE-Tx2 and/or the UE-Tx4, and use the same second of the selected two PRACHs for the second of the same two random access preamble transmissions on the UE-Tx2 and/or the UE-Tx4. For example, the UE may use the same PRACH (e.g., a same single PRACH) for the two random access preamble transmissions (e.g., the two random access preamble transmissions on a particular UE-Tx). The same PRACH (e.g., the same single PRACH) may be any one of the selected two PRACHs.

In another example, in case (c) in FIG. 8, where there is no association between the gNB-Tx (e.g., the gNB-Tx1, gNB-Tx2, the gNB-Tx3 and gNB-Tx4) and the gNB-Rx (e.g., the gNB-Rx1, gNB-Rx2, the gNB-Rx3 and gNB-Rx4), the UE may select four PRACHs. In case (c), the UE may perform the four random access preamble transmissions on a particular UE-Tx. For example, the UE may perform four repetitions of the random access preamble transmissions on a particular UE-Tx. Additionally or alternatively, the UE may perform the four repetitions of the random access preamble transmissions in the RACH transmission occasion. For example, the UE may perform the Msg.1 transmission on each UE-Tx (e.g., the UE-Tx1, the UE-Tx2, the UE-Tx3 and/or the UE-Tx4) using the selected four PRACHs. As described above, the four PRACHs selected by the UE may be determined based on the measurement of the downlink signal(s) and/or the downlink reference signal(s).

For example, in case (c), the UE (e.g., UE 102, 602, etc.) may perform the four random access preamble transmissions on each UE-Tx using the selected four PRACHs. In some approaches, the UE may use the selected four PRACHs during the four random access preamble transmissions on a particular UE-Tx. For example, the UE may use the first of the selected four PRACHs during the four random access preamble transmissions on the UE-Tx1, and use the second of the selected four PRACHs during the same four random access preamble transmissions on the UE-Tx1, and use the third of the selected four PRACHs during the same four random access preamble transmissions on the UE-Tx1, and use the fourth of the selected four PRACHs during the same four random access preamble transmissions on the UE-Tx1. Additionally or alternatively, the UE may use the first of the selected four PRACHs during the four random access preamble transmissions on the UE-Tx2, and use the second of the selected four PRACHs during the same four random access preamble transmissions on the UE-Tx2, and use the third of the selected four PRACHs during the same four random access preamble transmissions on the UE-Tx2, and use the fourth of the selected four PRACHs during the same four random access preamble transmissions on the UE-Tx2. For example, in case (c), the UE may use all of the selected four PRACH(s) (e.g., the first, the second, the third, and the fourth of the selected PRACHs) during the random access preamble transmission on a particular UE-Tx.

Additionally or alternatively, for example, in case (c), the UE may perform the four random access preamble transmissions on each UE-Tx using the selected four PRACHs. For example, the UE may use the selected four PRACHs for the four random access preamble transmissions on each UE-Tx. For example, the UE may use the same PRACH(s) (e.g., the same four PRACHs) during the four random access preamble transmissions on a particular UE-Tx. For instance, the UE may use the first of the selected four PRACHs for the first of the four random access preamble transmissions on the UE-Tx1, and use the same first one of the selected four PRACHs for the second of the same four random access preamble transmissions on the UE-Tx1, and use the same first one of the selected four PRACHs for the third of the same four random access preamble transmissions on the UE-Tx1, and use the same first one of the selected four PRACHs for the fourth of the same four random access preamble transmissions on the UE-Tx1. Additionally or alternatively, the UE may use the second of the selected four PRACHs for the first of the four random access preamble transmissions on the UE-Tx2, and use the same second of the selected four PRACHs for the second of the same four random access preamble transmissions on the UE-Tx2, and use the same second of the selected four PRACHs for the third of the same four random access preamble transmissions on the UE-Tx2, and use the same second of the selected four PRACHs for the fourth of the same four random access preamble transmissions on the UE-Tx2. The UE may perform the same process for the four random access preamble transmissions on the UE-Tx3 and/or the UE-Tx4 (e.g., the same third one of the selected four PRACHs may be used for the four random access preamble transmissions on the UE-Tx3, and/or the same fourth one of the selected four PRACHs may be used for the four random access preamble transmissions on the UE-Tx4). For example, the UE may use the same PRACH (e.g., a same single PRACH) for the four random access preamble transmissions (e.g., the four random access preamble transmissions on a particular UE-Tx). Additionally or alternatively, the same PRACH (e.g., the same single PRACH) may be any one of the selected four PRACHs.

The UE may determine the number of the selected PRACH(s) (e.g., one, two, or four) based on the information transmitted by the gNB (e.g., the information used for indicating the correspondence (e.g., the first correspondence, the second correspondence, and/or the third correspondence)). Additionally or alternatively, the UE may determine the number of the random access preamble transmissions based on the information transmitted by the gNB (e.g., the information used for indicating the correspondence (e.g., the first correspondence, the second correspondence, and/or the third correspondence)). Additionally or alternatively, the UE may determine the number of the random access preamble transmissions on a particular UE-Tx based on the information transmitted by the gNB (e.g., the information used for indicating the correspondence (e.g., the first correspondence, the second correspondence, and/or the third correspondence)). For example, the UE may determine the number of the repetition of the random access preamble transmissions on a particular UE-Tx based on the information transmitted by the gNB (e.g., the information used for indicating the correspondence (e.g., the first correspondence, the second correspondence, and/or the third correspondence)).

In a case that no information is configured (e.g., the information is not received, no value of the information is configured), the UE (e.g., UE 102, 602, etc.) may assume (e.g., consider, use, etc.) a first predetermined number(s) (e.g., two, or four) for the correspondence between the gNB-Tx, the gNB-Rx, the UE-Tx and/or the UE-Rx. For example, in the case that no information is configured, the UE may assume there is no association between the gNB-Tx, the gNB-Rx, the UE-Tx, and/or the UE-Rx (e.g., the same as in case (c)). Namely, the UE may select four PRACHs. Additionally or alternatively, in a case that no information is configured, the UE may assume a second predetermined number(s) (e.g., two, or four) for the number of the random access preamble transmissions (e.g., the repetition number of the random access preamble transmissions). For example, in the case that no information is configured, the UE may transmit the four random access preamble transmissions on a particular UE-Tx (e.g., the same as in case (c)). In some approaches, the first predetermined number and/or the second predetermined number (e.g., an assumption(s) of the UE behavior) may be defined (in advance, by the specifications, for example) and known information between the gNB (e.g., gNB 160, 660, etc.) and the UE.

In some approaches, the gNB may transmit information used for configuring the maximum number of the selected PRACH(s) (e.g., three). The information used for configuring the maximum number of the selected PRACH(s) may be identified by the PSS, the SSS, and/or the TSS. Additionally or alternatively, the information used for configuring the maximum number of the selected PRACH(s) may be included in the information for the random access configuration. Additionally or alternatively, the information used for configuring the maximum number of the selected PRACH(s) may be included in the MIB, the SIB(s) and/or the dedicated RRC message. For example, the gNB may configure the maximum number of the random access preamble (e.g., the selected separate random access preamble, the selected different random access preamble) transmissions on the one or more UE-Tx. For instance, in a case that the three is configured as the maximum number of the selected PRACH(s), the UE may perform the three random access preamble transmissions on each UE-Tx using the selected three PRACHs, as described above.

Additionally or alternatively, the gNB may transmit information used for configuring the maximum number of the UE-Tx(s) used for the random access preamble transmission (e.g., three). The information used for configuring the maximum number of the UE-Tx(s) used for the random access preamble transmission may be identified by the PSS, the SSS, and/or the TSS. Additionally or alternatively, the information used for configuring the maximum number of the UE-Tx(s) used for the random access preamble transmission may be included in the information for the random access configuration. Additionally or alternatively, the information used for configuring the maximum number of the UE-Tx(s) used for the random access preamble transmission may be included in the MIB, the SIB(s) and/or the dedicated RRC message. For example, in a case that three is configured as the maximum number of the UE-Tx(s) used for the random access preamble transmission, the UE may perform the random access preamble transmission on the UE-Tx1, the UE-Tx2 and/or the UE-Tx3 as described above, and may not perform the random access preamble transmission on the UE-Tx4 (i.e., the UE-Tx4 may be not used for the random access preamble transmission).

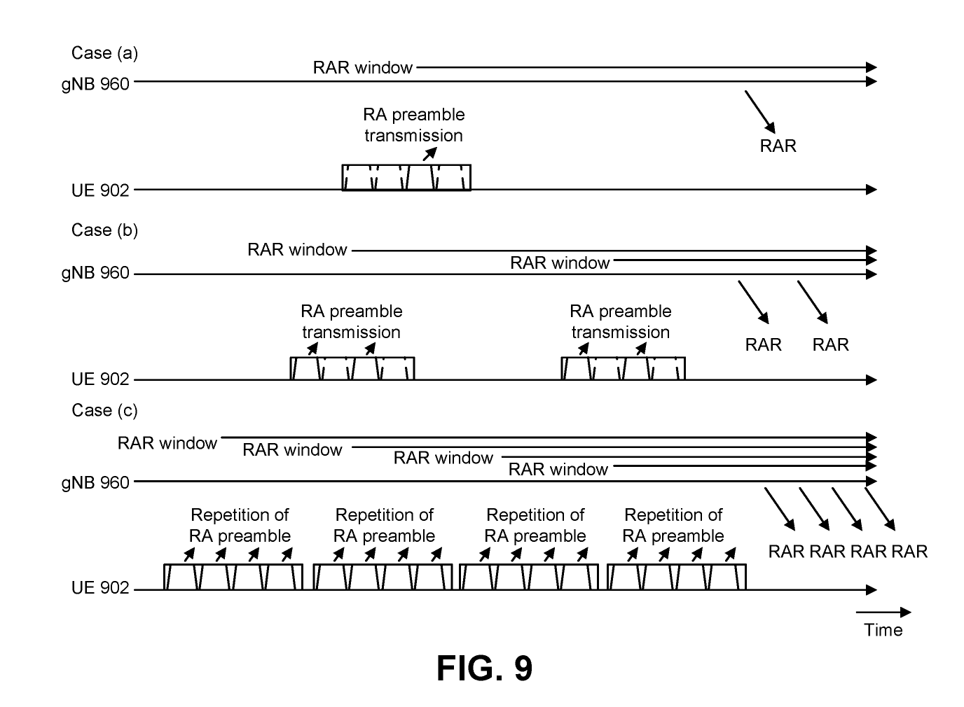

FIG. 9 shows another example of a random access procedure. In FIG. 9, as an example, case (a), case (b) and case (c) from FIG. 8 are described. For example, in case (a), based on the information transmitted by the gNB 960, the UE 902 may select one PRACH and perform the one random access preamble transmission (e.g., the one Msg.1 transmission) on each UE-Tx using the selected one PRACH, as described above. Additionally or alternatively, the UE 902 may receive the one RAR (Random Access Response) within the RAR window (Random Access Response window). Additionally or alternatively, based on the information contained in the RAR as described above, the UE 902 may perform the scheduled transmission (e.g., the Msg.3 transmission). For example, in case (a), the UE 902 may perform a single Msg.1 transmission before the end of the monitored the Random Access (RA) response window.

Also, for example, in case (b), based on the information transmitted by the gNB 960, the UE 902 may select the two PRACHs, and perform the two random access preamble transmission (e.g., the two Msg.1 transmissions) on each UE-Tx using the selected two PRACHs, as described above. In some approaches, the UE 902 may receive the two RARs within the two RAR windows. For example, each RAR within each RAR window may correspond to each random access preamble transmission on each UE-Tx. In some approaches, the UE 902 may receive the two RARs within a single RAR window. Additionally or alternatively, based on the information contained in the RAR as described above, the UE 902 may perform the scheduled transmission (e.g., the Msg.3 transmission). For example, in case (b), the UE 902 may perform multiple Msg.1 transmissions until the end of the RA response window.

In some approaches, the UE 902 may receive multiple RARs corresponding to the multiple random access preambles. Each RAR may contain information used for identifying each UE-Tx. For example, the RAR may contain information indicating an index of the two random access preamble transmissions. For instance, the RAR may contain information indicating an index of the two random access preamble transmissions on a particular UE-Tx. Additionally or alternatively, for example, the RAR may contain information indicating an index of the random access occasion. For instance, the RAR may contain information used for identifying the index of a set (e.g., the group) of the one or more random preamble transmissions on a particular UE-Tx. In some approaches, the RAR may contain information indicating an index of the one or more random access preamble transmissions (e.g., any one of the index of the one or more random access preamble transmissions on a particular UE-Tx). Additionally or alternatively, the RAR may contain information indicating an index of the set (e.g., the group) of the random access preamble transmission. Additionally or alternatively, the RAR may contain information indicating an index of the RA transmission occasion.

Also, for example, in case (c), based on the information transmitted by the gNB 960, the UE 902 may select the four PRACHs, and perform the four random access preamble transmissions (e.g., the four Msg.1 transmissions) on each UE-Tx using the selected four PRACHs, as described above. Also, the UE 902 may receive the four RARs within the four RAR window. For example, each RAR within each RAR window may correspond to each random access preamble transmission on each UE-Tx. In some approaches, the UE 902 may receive the four RARs within a single RAR window. Additionally or alternatively, based on the information contained in the RAR as above mentioned, the UE 902 may perform the scheduled transmission (e.g., the Msg.3 transmission). For example, in case (c), the UE 902 may perform multiple Msg.1 transmissions until the end of the RA response window.

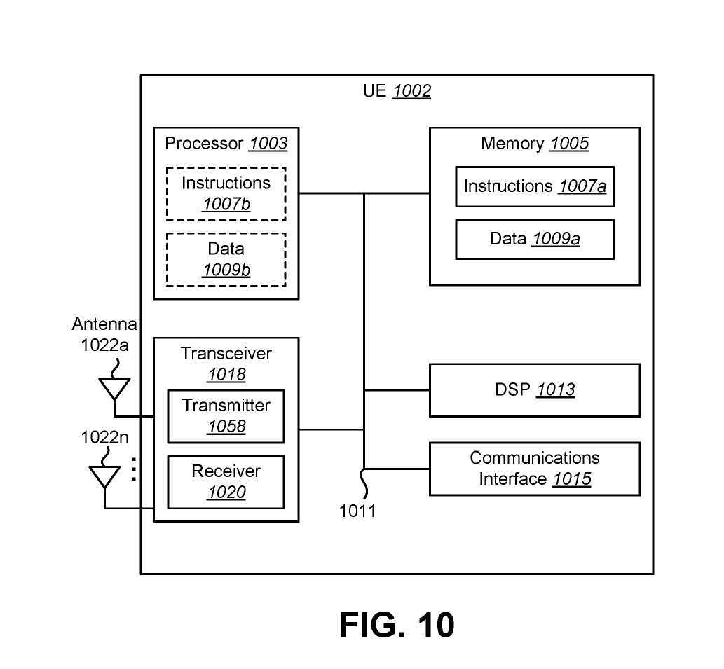

FIG. 10 illustrates various components that may be utilized in a UE 1002. The UE 1002 described in connection with FIG. 10 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described above.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 10 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 10 is a functional block diagram rather than a listing of specific components.

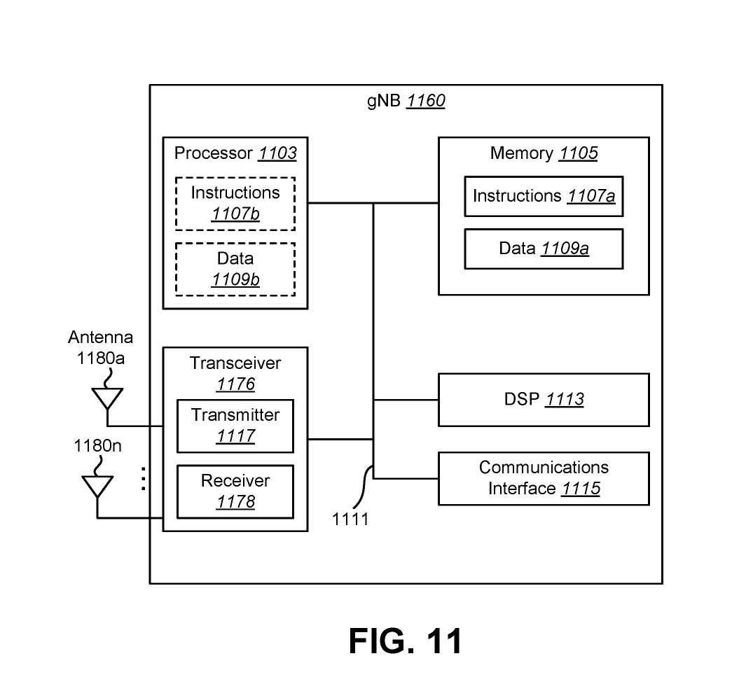

FIG. 11 illustrates various components that may be utilized in a gNB 1160. The gNB 1160 described in connection with FIG. 11 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include non-volatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described above.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 11 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 11 is a functional block diagram rather than a listing of specific components.

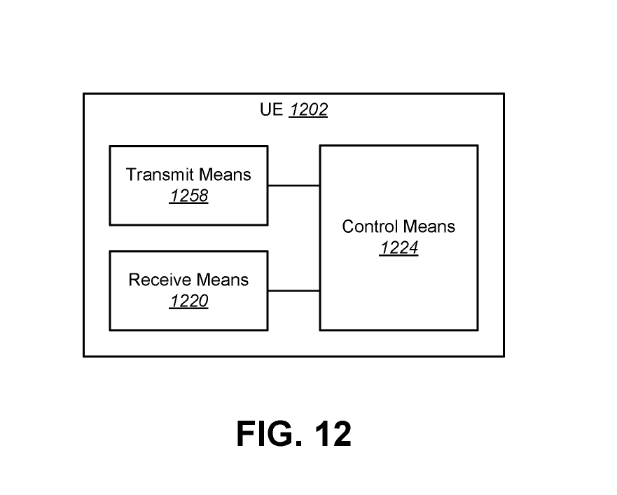

FIG. 12 is a block diagram illustrating one implementation of a UE 1202 in which systems and methods for performing uplink transmissions may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 10 above illustrates one example of a concrete apparatus structure of FIG. 12. Other various structures may be implemented to realize one or more of the functions of FIG. 1. For example, a DSP may be realized by software.

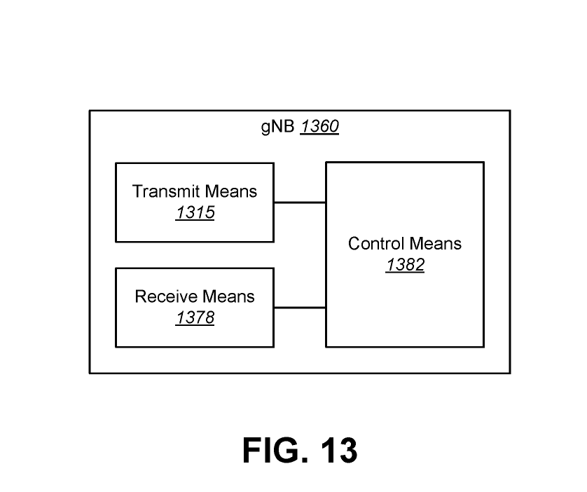

FIG. 13 is a block diagram illustrating one implementation of a gNB 1360 in which systems and methods for performing uplink transmissions may be implemented. The gNB 1360 includes transmit means 1317, receive means 1378 and control means 1382. The transmit means 1317, receive means 1378 and control means 1382 may be configured to perform one or more of the functions described in connection with FIG. 1 above. FIG. 11 above illustrates one example of a concrete apparatus structure of FIG. 13. Other various structures may be implemented to realize one or more of the functions of FIG. 1. For example, a DSP may be realized by software.

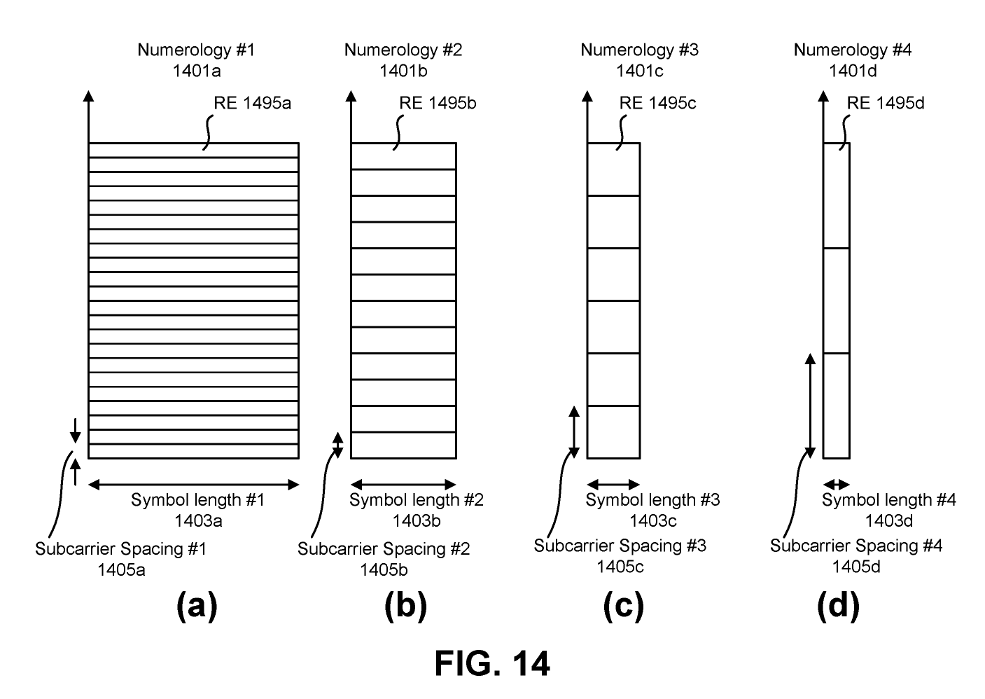

FIG. 14 shows examples of several numerologies 1401. The numerology #1 1401a may be a basic numerology (e.g., a reference numerology). For example, a RE 1495a of the basic numerology 1401a may be defined with subcarrier spacing 1405a of 15 kHz in frequency domain and 2048 Ts+CP length (e.g., 160 Ts or 144 Ts) in time domain (i.e., symbol length #1 1403a), where Ts denotes a baseband sampling time unit defined as 1/(15000*2048) seconds. For the i-th numerology, the subcarrier spacing 1405 may be equal to 15*2ⁱ and the effective OFDM symbol length 2048*2ⁱ*Ts. It may cause the symbol length is 2048*2ⁱ*Ts+CP length (e.g., 160*2ⁱ*Ts or 144*2ⁱ*Ts). In other words, the subcarrier spacing of the i+1-th numerology is a double of the one for the i-th numerology, and the symbol length of the i+1-th numerology is a half of the one for the i-th numerology. FIG. 14 shows four numerologies, but the system may support another number of numerologies. Furthermore, the system does not have to support all of the 0-th to the I-th numerologies, i=0, 1, . . . , I.

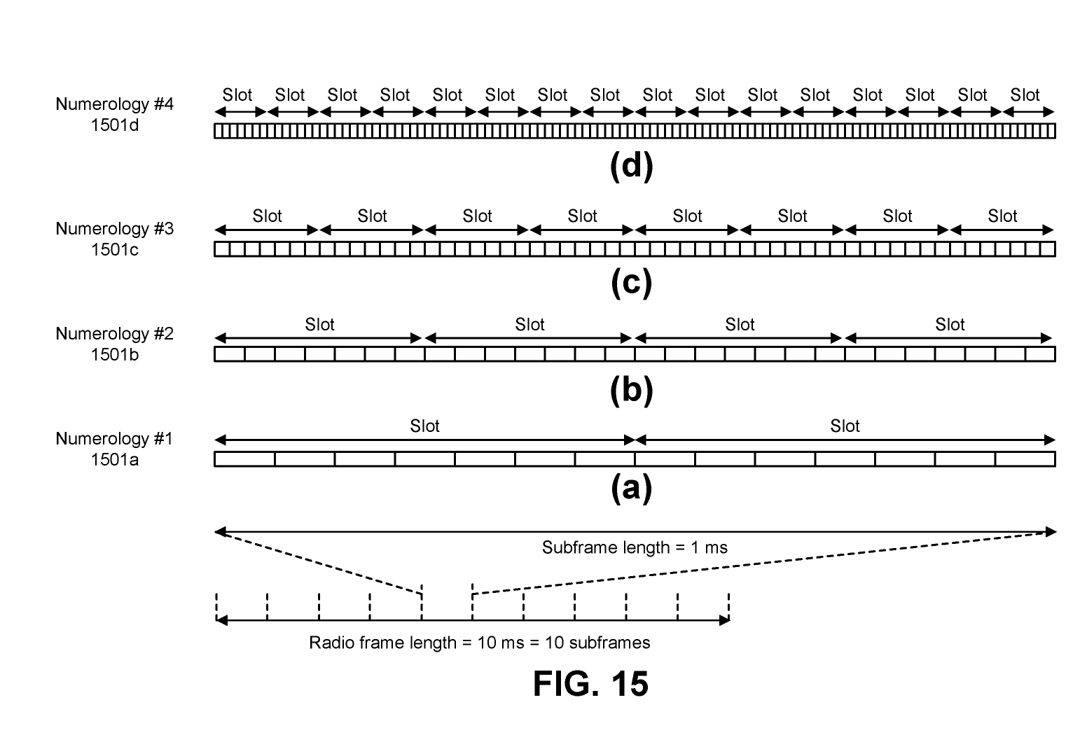

FIG. 15 shows examples of subframe structures for the numerologies 1501 that are shown in FIG. 14. Given that a slot 283 includes N^{DL}_{symb} (or N^{UL}_{symb})=7 symbols, the slot length of the i+1-th numerology 1501 is a half of the one for the i-th numerology 1501, and eventually the number of slots 283 in a subframe (i.e., 1 ms) becomes double. It may be noted that a radio frame may include 10 subframes, and the radio frame length may be equal to 10 ms.

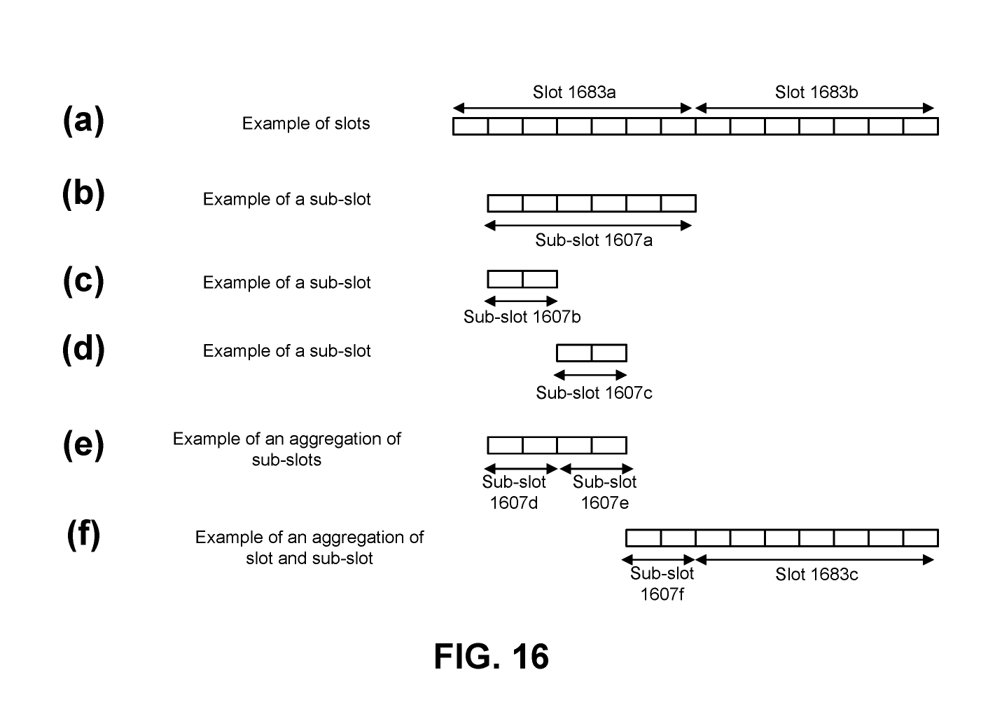

FIG. 16 shows examples of slots 1683 and sub-slots 1607. If a sub-slot 1607 is not configured by higher layer, the UE 102 and the eNB/gNB 160 may only use a slot 1683 as a scheduling unit. More specifically, a given transport block may be allocated to a slot 1683. If the sub-slot 1607 is configured by higher layer, the UE 102 and the eNB/gNB 160 may use the sub-slot 1607 as well as the slot 1683. The sub-slot 1607 may include one or more OFDM symbols. The maximum number of OFDM symbols that constitute the sub-slot 1607 may be N^{DL}_{symb}−1 (or N^{UL}_{symb}−1).

The sub-slot length may be configured by higher layer signaling. Alternatively, the sub-slot length may be indicated by a physical layer control channel (e.g., by DCI format).

The sub-slot 1607 may start at any symbol within a slot 1683 unless it collides with a control channel. There could be restrictions of mini-slot length based on restrictions on starting position. For example, the sub-slot 1607 with the length of N^{DL}_{symb}−1 (or N^{UL}_{symb}−1) may start at the second symbol in a slot 1683. The starting position of a sub-slot 1607 may be indicated by a physical layer control channel (e.g., by DCI format). Alternatively, the starting position of a sub-slot 1607 may be derived from information (e.g., search space index, blind decoding candidate index, frequency and/or time resource indices, PRB index, a control channel element index, control channel element aggregation level, an antenna port index, etc.) of the physical layer control channel which schedules the data in the concerned sub-slot 1607.

In cases when the sub-slot 1607 is configured, a given transport block may be allocated to either a slot 1683, a sub-slot 1607, aggregated sub-slots 1607 or aggregated sub-slot(s) 1607 and slot 1683. This unit may also be a unit for HARQ-ACK bit generation.

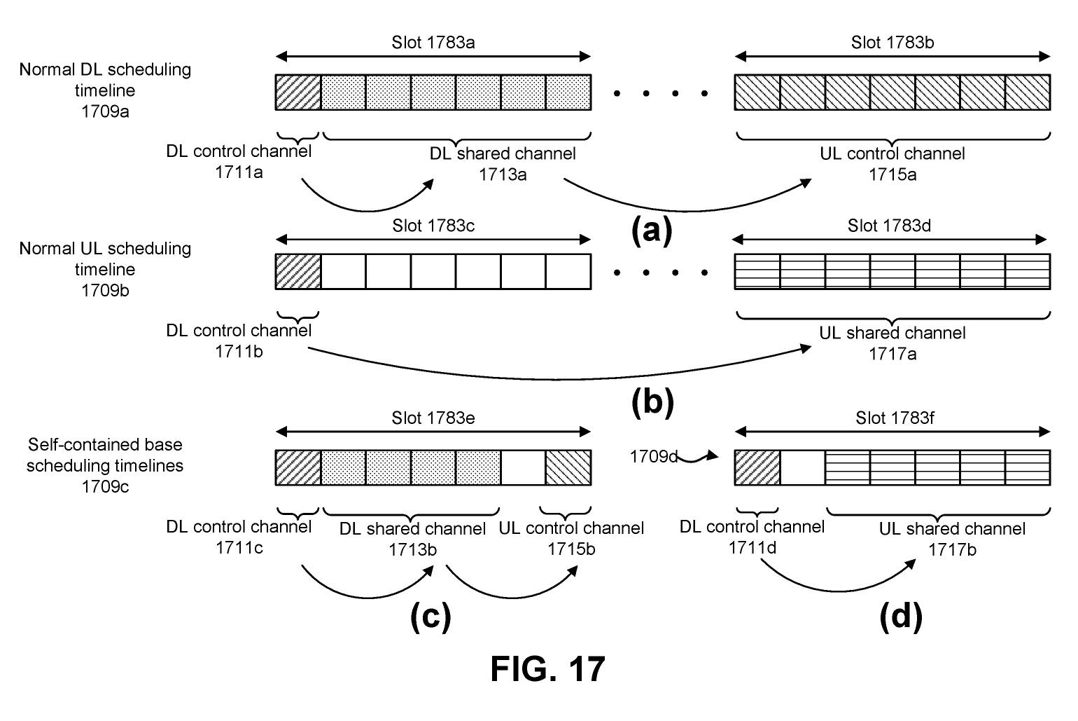

FIG. 17 shows examples of scheduling timelines 1709. For a normal DL scheduling timeline 1709a, DL control channels are mapped the initial part of a slot 1783a. The DL control channels 1711 schedule DL shared channels 1713a in the same slot 1783a. HARQ-ACKs for the DL shared channels 1713a (i.e., HARQ-ACKs each of which indicates whether or not transport block in each DL shared channel 1713a is detected successfully) are reported via UL control channels 1715a in a later slot 1783b. In this instance, a given slot 1783 may contain either one of DL transmission and UL transmission.

For a normal UL scheduling timeline 1709b, DL control channels 1711b are mapped the initial part of a slot 1783c. The DL control channels 1711b schedule UL shared channels 1717a in a later slot 1783d. For these cases, the association timing (time shift) between the DL slot 1783c and the UL slot 1783d may be fixed or configured by higher layer signaling. Alternatively, it may be indicated by a physical layer control channel (e.g., the DL assignment DCI format, the UL grant DCI format, or another DCI format such as UE-common signaling DCI format which may be monitored in common search space).

For a self-contained base DL scheduling timeline 1709c, DL control channels 1711c are mapped to the initial part of a slot 1783e. The DL control channels 1711c schedule DL shared channels 1713b in the same slot 1783e. HARQ-ACKs for the DL shared channels 1713b are reported in UL control channels 1715b, which are mapped at the ending part of the slot 1783e.

For a self-contained base UL scheduling timeline 1709d, DL control channels 1711d are mapped to the initial part of a slot 1783f. The DL control channels 1711d schedule UL shared channels 1717b in the same slot 1783f. For these cases, the slot 1783f may contain DL and UL portions, and there may be a guard period between the DL and UL transmissions.

The use of a self-contained slot may be upon a configuration of self-contained slot. Alternatively, the use of a self-contained slot may be upon a configuration of the sub-slot. Yet alternatively, the use of a self-contained slot may be upon a configuration of shortened physical channel (e.g., PDSCH, PUSCH, PUCCH, etc.).

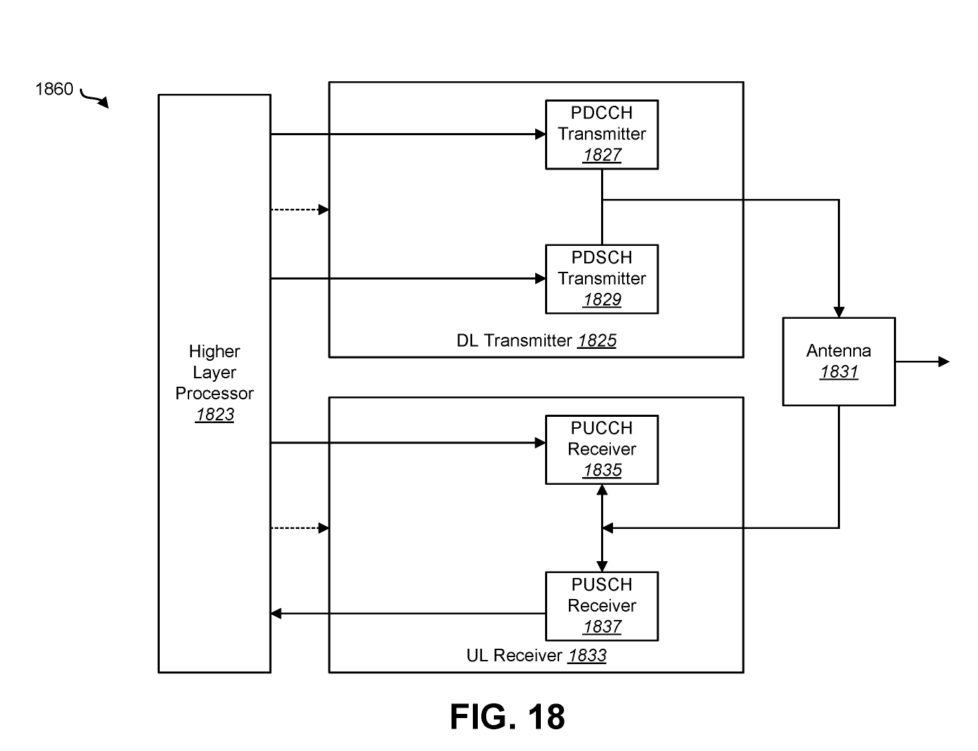

FIG. 18 is a block diagram illustrating one implementation of an gNB 1860. The gNB 1860 may include a higher layer processor 1823, a DL transmitter 1825, a UL receiver 1833, and one or more antenna 1831. The DL transmitter 1825 may include a PDCCH transmitter 1827 and a PDSCH transmitter 1829. The UL receiver 1833 may include a PUCCH receiver 1835 and a PUSCH receiver 1837.

The higher layer processor 1823 may manage physical layer's behaviors (the DL transmitter's and the UL receiver's behaviors) and provide higher layer parameters to the physical layer. The higher layer processor 1823 may obtain transport blocks from the physical layer. The higher layer processor 1823 may send/acquire higher layer messages such as an RRC message and MAC message to/from a UE's higher layer. The higher layer processor 1823 may provide the PDSCH transmitter transport blocks and provide the PDCCH transmitter transmission parameters related to the transport blocks.

The DL transmitter 1825 may multiplex downlink physical channels and downlink physical signals (including reservation signal) and transmit them via transmission antennas 1831. The UL receiver 1833 may receive multiplexed uplink physical channels and uplink physical signals via receiving antennas 1831 and de-multiplex them. The PUCCH receiver 1835 may provide the higher layer processor 1823 UCI. The PUSCH receiver 1837 may provide the higher layer processor 1823 received transport blocks.

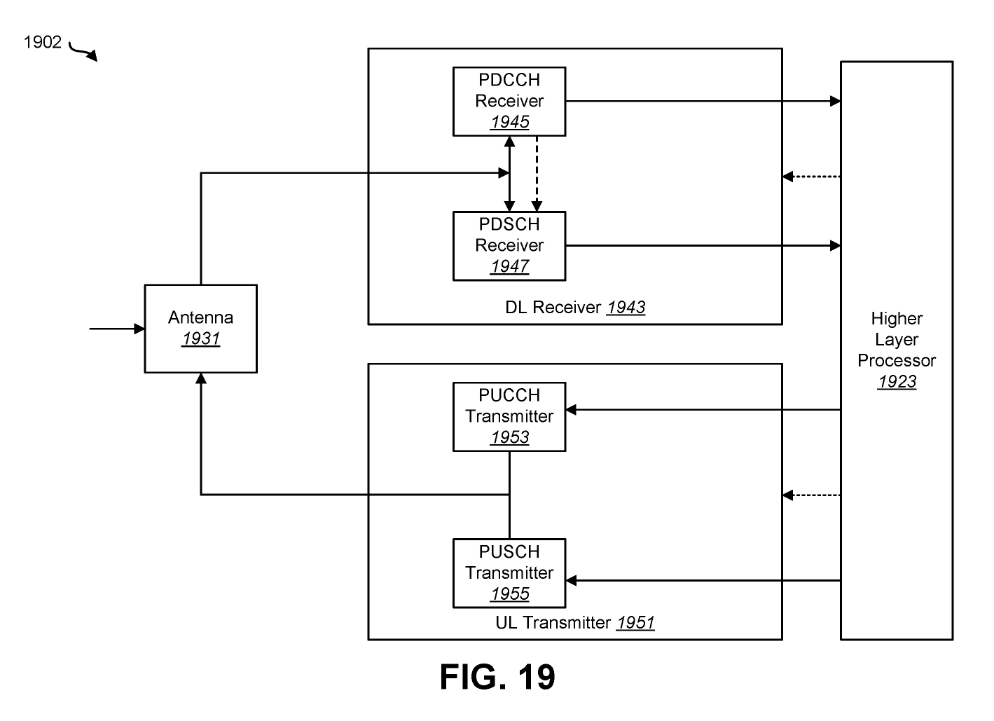

FIG. 19 is a block diagram illustrating one implementation of a UE 1902. The UE 1902 may include a higher layer processor 1923, a UL transmitter 1951, a DL receiver 1943, and one or more antenna 1931. The UL transmitter 1951 may include a PUCCH transmitter 1953 and a PUSCH transmitter 1955. The DL receiver 1943 may include a PDCCH receiver 1945 and a PDSCH receiver 1947.

The higher layer processor 1923 may manage physical layer's behaviors (the UL transmitter's and the DL receiver's behaviors) and provide higher layer parameters to the physical layer. The higher layer processor 1923 may obtain transport blocks from the physical layer. The higher layer processor 1923 may send/acquire higher layer messages such as an RRC message and MAC message to/from a UE's higher layer. The higher layer processor 1923 may provide the PUSCH transmitter transport blocks and provide the PUCCH transmitter 1953 UCI.

The DL receiver 1943 may receive multiplexed downlink physical channels and downlink physical signals via receiving antennas 1931 and de-multiplex them. The PDCCH receiver 1945 may provide the higher layer processor 1923 DCI. The PDSCH receiver 1947 may provide the higher layer processor 1923 received transport blocks.

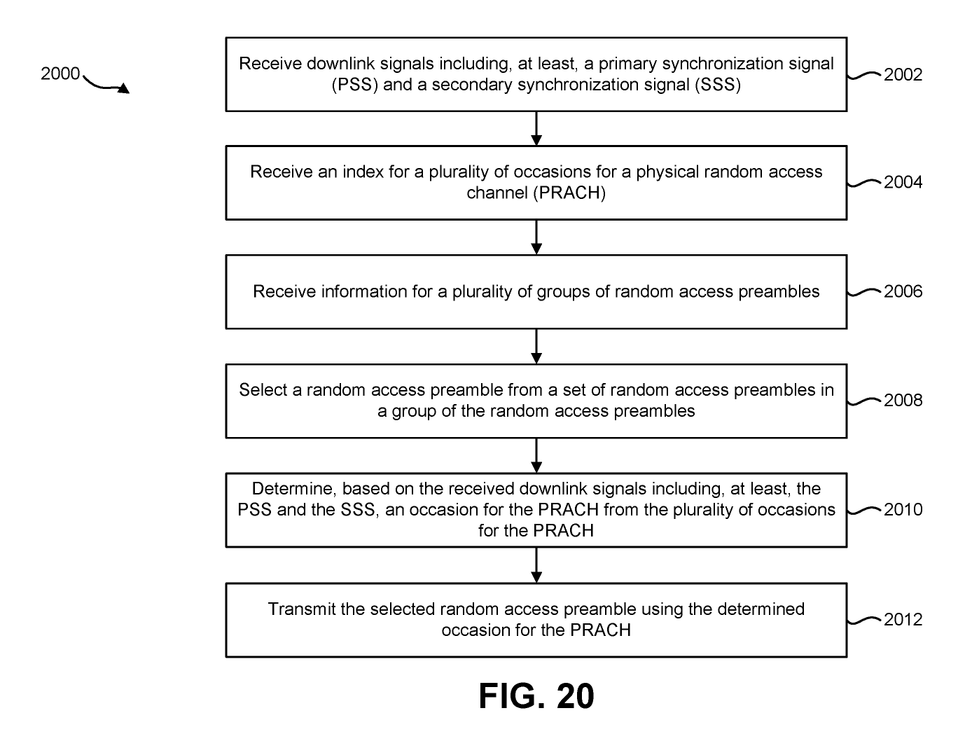

FIG. 20 is a flow diagram illustrating a communication method 2000 of a user equipment (UE) 102. The UE 102 may receive 2002 downlink signals including, at least, a primary synchronization signal (PSS) and a secondary synchronization signal (SSS).

The UE 102 may receive 2004 an index for a plurality of occasions for a physical random access channel (PRACH). Each of the plurality of occasions for the PRACH may be associated with each of the downlink signals including, at least, the PSS and the SSS.

The UE 102 may receive 2006 information for a plurality of groups of random access preambles. Each of the plurality of groups of the random access preambles may be associated with the each of the downlink signals including, at least, the PSS and the SSS.

The UE 102 may select 2008 a random access preamble from a set of random access preambles in a group of the random access preambles. The set of the random access preambles in the group of the random access preambles may be determined, based on the received downlink signals including, at least, the PSS and the SSS, from the plurality of groups of the random access preambles.

The UE 102 may determine 2010, based on the received downlink signals including, at least, the PSS and the SSS, an occasion for the PRACH from the plurality of occasions for the PRACH. The UE 102 may transmit 2012 the selected random access preamble using the determined occasion for the PRACH.

The selected random access preamble may be transmitted 2012 in a contention based random access procedure or in a non-contention based random access procedure. The set of the random access preambles in the group of the random access preambles may be determined, based on a measurement of the received downlink signals including, at least, the PSS and the SSS, from the plurality of groups of the random access preambles. The occasion for the PRACH may be determined, based on the measurement of the received downlink signals including, at least, the PSS and the SSS, from the plurality of occasions for the PRACH.

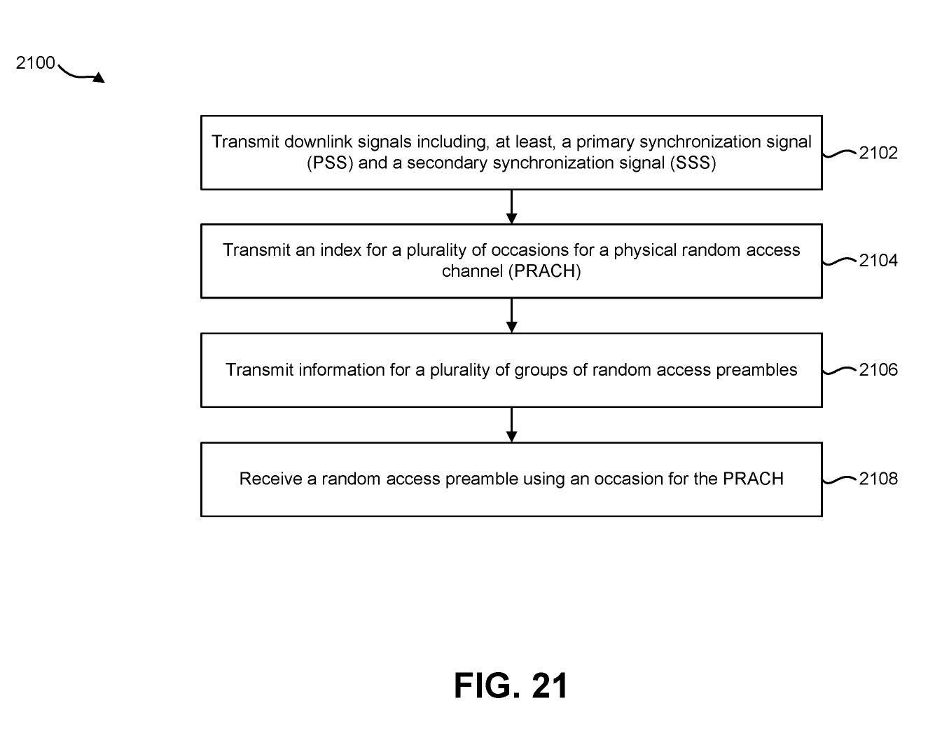

FIG. 21 is a flow diagram illustrating a communication method 2100 of a base station apparatus (gNB) 160. The gNB 160 may transmit 2102 downlink signals including, at least, a primary synchronization signal (PSS) and a secondary synchronization signal (SSS).

The gNB 160 may transmit 2104 an index for a plurality of occasions for a physical random access channel (PRACH). Each of the plurality of occasions for the PRACH may be associated with each of the downlink signals including, at least, the PSS and the SSS.

The gNB 160 may transmit 2106 information for a plurality of groups of random access preambles. Each of the plurality of groups of the random access preambles may be associated with each of the downlink signals including, at least, the PSS and the SSS.

The gNB 160 may receive 2108 a random access preamble using an occasion for the PRACH. The random access preamble may be selected from a set of random access preambles in a group of the random access preambles. The set of the random access preambles in the group of the random access preambles may be determined, based on the received downlink signals including, at least, the PSS and the SSS, from the plurality of the random access preambles. The occasion for the PRACH may be determined, based on the received downlink signals including, at least, the PSS and the SSS, from the plurality of occasions for the PRACH.

The random access preamble may be received in a contention based random access procedure or in a non-contention based random access procedure. The set of the random access preambles in the group of the random access preambles may be determined, based on a measurement of the transmitted downlink signals including, at least, the PSS and the SSS, from the plurality of groups of the random access preambles. The occasion for the PRACH may be determined, based on the measurement of the transmitted downlink signals including, at least, the PSS and the SSS, from the plurality of occasions for the PRACH.

It should be noted that names of physical channels described herein are examples. The other names such as “NRPDCCH, NRPDSCH, NRPUCCH and NRPUSCH,” “new Generation-(G)PDCCH, GPDSCH, GPUCCH and GPUSCH” or the like can be used.

The term “computer-readable medium” refers to any available medium that can be accessed by a computer or a processor. The term “computer-readable medium,” as used herein, may denote a computer- and/or processor-readable medium that is non-transitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A user equipment comprising:
receiving circuitry configured to:
receive downlink signals including, at least, a primary synchronization signal (PSS) and a secondary synchronization signal (SSS),
receive an index for a plurality of occasions for a physical random access channel (PRACH), each of the plurality of occasions for the PRACH being associated with each of the downlink signals including, at least, the PSS and the SSS,
receive information for a plurality of groups of random access preambles, each of the plurality of groups of the random access preambles being associated with the each of the downlink signals including, at least, the PSS and the SSS;
higher layer processing circuitry configured to:
select a random access preamble from a set of random access preambles in a group of the random access preambles, the set of the random access preambles in the group of the random access preambles being determined, based on the received downlink signals including, at least, the PSS and the SSS, from the plurality of groups of the random access preambles,
determine, based on the received downlink signals including, at least, the PSS and the SSS, an occasion for the PRACH from the plurality of occasions for the PRACH; and
transmitting circuitry configured to transmit the selected random access preamble using the determined occasion for the PRACH.

2. The user equipment of claim 1, wherein
the selected random access preamble is transmitted in a contention based random access procedure or in a non-contention based random access procedure.

3. The user equipment of claim 2, wherein
the set of the random access preambles in the group of the random access preambles is determined, based on a measurement of the received downlink signals including, at least, the PSS and the SSS, from the plurality of groups of the random access preambles, and
the occasion for the PRACH is determined, based on the measurement of the received downlink signals including, at least, the PSS and the SSS, from the plurality of occasions for the PRACH.

4. A base station apparatus comprising:
transmitting circuitry configured to:
transmit downlink signals including, at least, a primary synchronization signal (PSS) and a secondary synchronization signal (SSS),
transmit an index for a plurality of occasions for a physical random access channel (PRACH), each of the plurality of occasions for the PRACH being associated with each of the downlink signals including, at least, the PSS and the SSS,
transmit information for a plurality of groups of random access preambles, each of the plurality of groups of the random access preambles being associated with the each of the downlink signals including, at least, the PSS and the SSS; and
receiving circuitry configured to receive a random access preamble using an occasion for the PRACH, wherein
the random access preamble is selected from a set of random access preambles in a group of the random access preambles,
the set of the random access preambles in the group of the random access preambles is determined, based on the transmitted downlink signals including, at least, the PSS and the SSS, from the plurality of groups of the random access preambles, and
the occasion for the PRACH is determined, based on the transmitted downlink signals including, at least, the PSS and the SSS, from the plurality of occasions for the PRACH.

5. The base station apparatus of claim 4, wherein
the random access preamble is received in a contention based random access procedure or in a non-contention based random access procedure.

6. The base station apparatus of claim 5, wherein
the set of the random access preambles in the group of the random access preambles is determined, based on a measurement of the transmitted downlink signals including, at least, the PSS and the SSS, from the plurality of groups of the random access preambles, and
the occasion for the PRACH is determined, based on the measurement of the transmitted downlink signals including, at least, the PSS and the SSS, from the plurality of occasions for the PRACH.

7. A communication method of a user equipment comprising:
receiving downlink signals including, at least, a primary synchronization signal (PSS) and a secondary synchronization signal (SSS);
receiving an index for a plurality of occasions for a physical random access channel (PRACH), each of the plurality of occasions for the PRACH being associated with each of the downlink signals including, at least, the PSS and the SSS;
receiving information for a plurality of groups of random access preambles, each of the plurality of groups of the random access preambles being associated with the each of the downlink signals including, at least, the PSS and the SSS;
selecting a random access preamble from a set of random access preambles in a group of the random access preambles, the set of the random access preambles in the group of the random access preambles being determined, based on the received downlink signals including, at least, the PSS and the SSS, from the plurality of groups of the random access preambles;
determining, based on the received downlink signals including, at least, the PSS and the SSS, an occasion for the PRACH from the plurality of occasions for the PRACH; and
transmitting the selected random access preamble using the determined occasion for the PRACH.

8. The communication method of claim 7, wherein
the selected random access preamble is transmitted in a contention based random access procedure or in a non-contention based random access procedure.

9. The communication method of claim 8, wherein
the set of the random access preambles in the group of the random access preambles is determined, based on a measurement of the received downlink signals including, at least, the PSS and the SSS, from the plurality of groups of the random access preambles, and
the occasion for the PRACH is determined, based on the measurement of the received downlink signals including, at least, the PSS and the SSS, from the plurality of occasions for the PRACH.

10. A communication method of a base station apparatus comprising:
transmitting downlink signals including, at least, a primary synchronization signal (PSS) and a secondary synchronization signal (SSS);
transmitting an index for a plurality of occasions for a physical random access channel (PRACH), each of the plurality of occasions for the PRACH being associated with each of the downlink signals including, at least, the PSS and the SSS;
transmitting information for a plurality of groups of random access preambles, each of the plurality of groups of the random access preambles being associated with each of the downlink signals including, at least, the PSS and the SSS; and
receiving a random access preamble using an occasion for the PRACH, wherein
the random access preamble is selected from a set of random access preambles in a group of the random access preambles,
the set of the random access preambles in the group of the random access preambles is determined, based on the transmitted downlink signals including, at least, the PSS and the SSS, from the plurality of the random access preambles, and
the occasion for the PRACH is determined, based on the transmitted downlink signals including, at least, the PSS and the SSS, from the plurality of occasions for the PRACH.

11. The communication method of claim 10, wherein
the random access preamble is received in a contention based random access procedure or in a non-contention based random access procedure.

12. The communication method of claim 11, wherein
the set of the random access preambles in the group of the random access preambles is determined, based on a measurement of the transmitted downlink signals including, at least, the PSS and the SSS, from the plurality of groups of the random access preambles, and
the occasion for the PRACH is determined, based on the measurement of the transmitted downlink signals including, at least, the PSS and the SSS, from the plurality of occasions for the PRACH.
